(19) United States
(12) Patent Application Publication
(10) Pub. No.: US 2004/0068520 A1
(43) Pub. Date: Apr. 8, 2004

(54) Information management system

(76) Inventor: Noboru Masaoka, Tokyo (JP)

Correspondence Address: Glenn Patent Group, Suite L, 3475 Edison Way, Menlo Park, CA, 94025, US

(21) Appl. No.: 10/381,343

(22) PCT Filed: Aug. 27, 2001
(86) PCT No.: PCT/JP01/07364

(30) Foreign Application Priority Data
Sep. 20, 2000 (JP) 2000-284843
Nov. 29, 2000 (JP) 2000-362455
Aug. 15, 2001 (JP) 2001-246551

(51) Int. Cl. G06F 17/00

(52) U.S. Cl. 707/104.1

(57) ABSTRACT

An information management system in which information related to a spatial location is registered and at least a part of the information is outputted by using a spatial condition as a clue. A space is pre-divided in a plurality of unit zones and the space is again re-divided in another plurality of unit zones (102, 103). The system has Information input means 12 enabling an information provider 11 to input information including a desired spatial location and DB registration means 134 enabling inputted information to be registered in a database (DB) 105. The system also has request input means 142 enabling an information recipient 12 to input a request including a desired spatial condition, DB retrieving means 144 enabling information to be selected in an information DB 105 in response to an inputted request, and information output means 145 enabling selected information to be outputted. The system further has location optimization means 133 (143) representing a data in a smaller size by combining less unit zones when at least any one of the spatial location and the spatial condition and enabling a spatially distorted area to be inputted.

### BACKGROUND OF THE INVENTION

1. Technical Field

The present invention relates to an information management device which enables information to be registered in relation to a spatial location and enables the information to be outputted using a spatial condition as a clue, and more specifically, to an information management system which enables information to be inputted and outputted in an information management device and a terminal connected through a predetermined communication network.

2. Background Art

In this application, a database is referred to as the “DB” and the DB basically represents the database in a text format unless any special explanation is added. The text-format DB by Oracle is known as the typical products. Drawings are used based on a map database in a vector format, apart from the DB in the text format. In addition, an information provider mentioned in the present application denotes a terminal to be operated by the information provider, and an information recipient denotes a terminal to be operated by the information recipient.

1. Conventional Media

Conventionally, it is known that a location of a store is inserted on a map and the store is advertised on another column or page using printed papers. An advertisement to a listener or a viewer through the one-way media such as television receiver, radio receiver and etc. is also well known.

However, an advertisement method using printed papers causes a time lag or delay of several weeks or several months from the time of requesting the advertisement till actually distributing or selling the printed matters. Therefore, the method using the printed matters has a problem being liable to lose the novelty and reliability of information. The method using the one-way media also has the problems that it is difficult to obtain any reaction from the listeners and viewers and the costs for advertisement are generally high. There is also another problem that it is not easy for a client having a small-scale business to request his/her advertisement due to complicate procedures.

In addition, each advertiser, i.e., each information provider, has a desired commercial territory and intends to advertise in that territory. As the territory is expected to be different according to each advertiser, it is also expected that the area be spatially distorted. On the other hand, each advertisee, i.e., each information recipient, has a desired territory for activity and desires to receive an advertisement within the corresponding territory of activity. The activity territory is expected to be different from one another according to advertisees and thus it is expected that the area of activity be spatially distorted. However, in the conventional media, it is difficult to advertise in the desired commercial territory and to receive the advertisement in the desired territory of activity by satisfying the requests of both advertiser and advertisee.

2. Geographic Information System (GIS)

Geographic Information System (hereinafter referred to as “GIS”) is defined as a technology for generally managing and processing the data having location information (spatial data) and visually displaying it using computers, using the geographic location as a clue. Thereby, the GIS enables the high level analysis and prompt determination (which cited from “National Land Spatial Data Basic Standard and Improvement Plan” by the Liaison Conference for Agencies Relating to Geographic Information System).

The GIS is utilized, for example, for selecting an appropriate location for opening a store when planing to newly open the store. For example, the GIS is used in estimating the number of customers of the store after inputting the locations of one's own store and other competing stores in a map data by using an approach such as the Voronoi division, etc. According to the Voronoi division (“Thiessen division” in another name), an influenced territory (commercial territory, train station territory, etc.) for each point (store, etc.) is theoretically indicated by using the perpendicular bisectors between corresponding points of a plurality of points on points (stores, etc.).

As the GIS has been disclosed through the Internet, an information management system of enabling various information to be registered in relation to spatial location (for example, Japanese Patent No. 2756483) and an information management system of enabling at least a part of information to be output using a spatial condition as a clue (for example, Japanese Patent No. 3011098) are already opened. The technique of the information management systems is implemented as web-sites on the Internet, thereby enabling various advertisements between the advertisers and advertisees. Basically, in the information management system, the information provider can register the point information (stores, etc.) as the spatial location, the information recipient can receive various information within a corresponding territory because he can designate a simple range such as an administrative district or a zip code as the spatial condition. Each information management system enables the information provider to register various information in relation to one point in space, however, it does not enable to register the information in relation to a desired space territory. The information recipient can receive the information only using a simple spatial condition of designating an address or a zip code or a desired rectangle.

FIG. 44 is a block diagram illustrating an information management system in response to an advertisement of service as provided within a spatial territory. The information management system manages advertisements of services such as a fire station, a police station and an emergency hospital. In the system mentioned above, any territory does not basically overlap two or more organizations and it is clearly divided spatially. Once a spatial territory is registered, the service in a corresponding territory is not often changed.

In the figure, an information management device 91 for managing various information and a terminal 921 (922) of a user are connected to a communication network 93 through a communication unit 913 and another communication unit such as a modem not shown in the figure, respectively. The information management device 91 performs various processes by an operation of an operator 914 or it is operable in the terminal 921(922) without intervening the operation 914. When a request from the terminal 921 is received by request input means 915, the information management device 91 identifies a type of a corresponding request (for example, the emergency hospital) by type identifying means 916; it indicates a location (xy) by location indicating means 917; and it detects a service provider (for example, the emergency hospital n17) in response by combining an information location chart (map DB) 912. The information location chart 911 comprises layers by service types. The information management device 91 selects the corresponding information by the service provider in an information content DB (attribute DB) 912 and it outputs the selected information by information output means 918. A corresponding information management system is implemented, for example, as an information providing service of a telephone company.

In the information management system, however, in order to manage information in different service territories classified by types of service providers who, without any limitation, take part in one spatial territory such as a delivery pizza house and a delivery lunch shop, it is required to register each different service territory, to easily change the service territory in response to the service provider, and to add the service provider without limitation on the number of registrations.

Further, it is also required to designate a spatially distorted area, for example, in order that an engineer with a city hall can receive necessary information about the route through which the residents in a desired area can escape when a disaster occurs.

3. First and Second Schemes for Information Management System

FIGS. 45(a) and (b) are block diagrams illustrating a request of each of the information management systems according to a first scheme and a second scheme which is processed in a vector format to indicate a spatially distorted area with respect to a spatial location.

The information management system according to the first scheme shown in FIG. 45(a) comprises a mouse 945 as an input unit for an information recipient to input a request such as a spatial condition, etc.; a display 946 as an output unit to verify the request; a referential chart 944 co complete an input of the request; an information location chart 941 in which spatial location of various information is registered; and various means and DBs not shown in the figure. The information location chart 941 consists of a layer 942 for each of delivery lunch shops A to W and a layer 943 for each of delivery pizza houses. The delivery territory of each shop is registered in each layer in a vector format.

The information management system according to the second scheme shown in FIG. 45(b) comprises a mouse 955 as an input unit for an information recipient to input a request such as a spatial condition, etc.; a display 956 as an output unit to verify the request; a referential chart 954 to complement an input of the request; an information location chart 951 in which a spatial location of various information is registered; and various means and DBs not shown in the figure. The information location chart 951 consists of layers classified by information types such as a layer 952 for a delivery lunch shop and a layer 953 for a delivery pizza house. The delivery territory of each shop is registered in a vector format, being overlapped on the layers classified by information types.

In either information management system shown in FIG. 45(a) or FIG. 45(b), if a ‘type=delivery lunch shop’ and a spatial condition are inputted, a corresponding spatial condition is associated with a whole delivery territory of delivery lunch shops, and the information of the delivery lunch shop capable of satisfying the corresponding spatial condition is outputted to the information recipient.

However, the information management system has a problem that time for retrieving the DB longer is lengthened in proportion to the number of service providers as registered. This is because the information location chart is registered in a vector format. In order to analyze the overlap of the spatial location in the vector format and the spatial condition in the vector format, all coordinates forming each location and each condition should be connected and closed. If the information management system manages various information in a nation-wide scale, for example, if a delivery lunch shop K to provide the delivery service within Okinawa Prefecture is registered, the spatial location of the delivery lunch shop K must be analyzed even though a “spatial condition=Hatsudai in Shibuya Ward” is inputted. Therefore, it is difficult to construct a practical information management system in both schemes of FIG. 45(a) and FIG. 45(b). Furthermore, the information management device according to the scheme in FIG. 45(a) is not efficient with respect to its management and operation since the number of map layers is easily increased or decreased as a plurality of service providers are registered/deleted.

4. Third and Fourth Ideas for Information Management System

FIGS. 46(a) and (b) are block diagrams illustrating each main part of information management systems according to a third scheme and a fourth scheme which are processed in a text format to indicate a spatially distorted area as a spatial location.

The information management system according to the third scheme shown in FIG. 46(a) comprises a mouse 964 as an input unit for an information recipient to input a request such as a spatial condition, etc; a display 965 as an output unit to verify the request; a referential chart 963 to complement an input of an main part; a unit zone chart 961 to spatially divide a corresponding territory; an information location DB 962 in which a spatial location of various information is registered; and various means and DBs not shown in the figure. In the information location DB 962, the delivery territory of each of delivery lunch shops A˜W is represented by combining unit zones on the basis of the unit zone chart 961 and it is registered in a text format. If a ‘type=delivery lunch shop’ is inputted and a spatial condition is inputted by an information recipient, the corresponding spatial condition is represented by combined the unit zones on the basis of the unit zone chart 961. Being associated with the whole records of delivery lunch shops in the information location DB 962, the information of all delivery lunch shop which can provide the delivery service by satisfying the corresponding spatial condition is outputted to the information recipient.

Compared to the first and second schemes, the information management system of the third scheme has an advantage that time for retrieving the DB is not almost affected by the number of registered service providers. However, in the information management system of the third scheme, there is a problem that a large number of records must be added to the information location DB 962 to represent a sufficiently broader area than that of the unit zone chart 961 as already prepared. Another problem is that it is impossible to represent a smaller area than that of the unit zone chart 961 as prepared.

The information management system according to the fourth scheme shown in FIG. 46(b) comprises a mouse 974 as an input unit for an information recipient to input a request such as a spatial condition, etc.; a display 975 as an output unit to verify the request; a referential chart 973 to complement an input of the request; an unit zone chart 971 to spatially divide a corresponding territory; an information location DB 972 in which a spatial location of various information is registered; and various means and DBs not shown in the figure. The unit zone chart 971 comprises two layers, and one unit zone (for example, 5) of the lower layer in the figure corresponds to the combination of a plurality of unit zones of the upper layer (51-56). In the information position DB 972, the delivery territory of each of delivery lunch shops A˜W is registered in a text format, being represented in a smaller data size by combining less unit zones of each layer on the basis of the unit zone chart 971. For example, the deliver territory of D shop registered in the information location DB 962 shown in FIG. 45(a) is simplified as “5+62+ . . . ” in the information location DB 972 shown in 46(b) and, practically, records are added into the information location DB 972 by the number of the unit zones, and the number of records are decreasingly registered as many as the number of records simplified in the information location DB 962.

Compared to the third scheme, the information management system of the fourth scheme has advantages that a wide area can be represented as lesser unit zones, and a smaller area can be represented by preparing a number of layers in the unit zone chart 971. However, the information management system of the fourth scheme has a problem that an information provider and an information recipient should select a suitable layer from a plurality of layers in the unit zone chart 971 and select a desired unit zone in order to input desired spatial location and condition. Furthermore, they should repeat the processes until they finish inputting the desired spatial location and spatial condition.

5. Summary of Problems

As described above, the information management system which processes the spatial location and spatial condition in a vector format has the problem that the time for retrieving the DB is lengthened in proportion to the number of service providers. The information management system which processes the spatial location and spatial condition in a text format also has the problem that the information recipient should bear the burden to input the spatial condition in proportion to the complexity of the spatial condition and the other problem that the information provider should bear the burden to input the spatial location in proportion to the complexity of the spatial location.

An object of the present invention is to provide an information management device which enables information to be registered in relation to a spatial location and which enables the information to be outputted by using a spatial condition as a clue, and more particularly, to provide an information management system which enables information to be inputted and outputted in an information management device and a terminal as connected through a predetermined communication network. Specifically, an object of the present invention is to further provide an information management system in which at least any one of the spatial location and the spatial condition makes it possible to indicate a spatially distorted area and the time for retrieving the DB is hardly affected by the amount of information as registered, thereby being easily used.

### SUMMARY OF THE INVENTION

To achieve the above objects, there is provided an information management system which enables information to be registered from a terminal to a database (DB) connected to a host computer through a predetermined communication network and which pre-divides a space into a plurality of unit zones and re-dividing the space into at least another plurality of unit zones, comprises information input means enabling for an information provider to input information including a desired spatial location; location optimization means for representing a data in a smaller size by combining less unit zones when the spatial location is input; and DB registration means for enabling input information to be registered in the DB.

Further, an information management system which enables information to be outputted to a terminal from a database (DB) connected to a host computer through a predetermined communication network, in which a space is pre-divided into a plurality of unit zones and re-divided into at least another plurality of unit zones and information including a spatial location is registered in the DB, comprises request input means enabling for an information recipient to input a request for a desired spatial condition; location optimization means for representing a data in a smaller size by combining less unit zones when the spatial condition is inputted; DB retrieving means enabling information to be selected from the DB in response to an input request; and information output means for enabling selected information to be outputted.

Further, an information management system which enables information to be registered from a terminal to a database (DB) connected to a host computer through a predetermined communication network and the information to be output from the DB to the terminal, in which a space is pre-divided into a plurality of unit zones and re-divided into at least another plurality of unit zones, comprises information input means enabling an information provider to input information a desired spatial location, DB registration means enabling input information to be registered in the DB; request input means enabling for an information recipient to input a request including a desired spatial condition; DB retrieving means enabling information to be selected in the DB in response to an input request; information output means enabling selected information to be outputted; and location optimization means representing a data in a smaller size by combining less unit zones when at least either the spatial location or the spatial condition is inputted.

Further, at least a part of the terminal in which a space is pre-divided into a plurality of unit zones and re-divided into another plurality of unit zones, comprises an input unit for inputting information or request; an output unit for verifying or outputting the information; a DB for registering information including a spatial location; information input means for inputting information including a desired spatial location; DB registration means for registering inputted information in the DB; request input means for inputting a request including a desired spatial condition; DB retrieving means for selecting information in the DB in response to an inputted request; information output means for outputting selected information; and location optimization means for represent a data in a smaller size by combining less unit zones when at least either a spatial location and a spatial condition is inputted.

Further, at least in the part of the terminal, at least a part of the information outputted in the DB connected to the host computer is registered in the DB.

Further, at least in the part of the terminal, at least a part of the information outputted in the DB is registered in the DB connected to the host computer.

Further, at least in the part of the terminal, at least a part of the information registered in the DB is opened to the public through the communication network; information of the location of the terminal which opens at least the part of the information is registered in the host computer; and the information is opened through the communication network; and the opened information is referred to by other terminals.

Further, the host computer comprises an input unit for inputting information and request and an output unit for verifying and outputting the information and request, the host computer being used as a terminal.

The host computer and the DB are divided into a plurality of parts, which are respectively connected to the communication network.

An information management device enabling information to be registered in a DB, in which a space is pre-divided into a plurality of unit zones and the space is re-divided into another plurality of unit zones, comprises an input unit for inputting information; an output unit for outputting the information; a DB for registering information including a spatial location; information input means for inputting information including a desired spatial location; DB registration means for registering inputted information in the DB; location optimization means for representing a data in a smaller size by combining less unit zones.

An information management device enabling information to be outputted in a DB, in which a space is pre-divided into a plurality of unit zones and the space is re-divided into another plurality of unit zones, comprises an input unit for inputting a request; an output unit for outputting information; a DB for registering information including a spatial location; request input means for inputting a request including a desired spatial condition; DB retrieving means for selecting information from the DB in response to an inputted request; information output means for outputting selected information; location optimization means for representing the unit zones to be smaller by combining less unit zones when the spatial condition is inputted.

An information management device enabling information to be registered and outputted in a DB, in which a space is pre-divided into a plurality of unit zones and the space is re-divided into at least another plurality of unit zones, comprises an input unit for inputting information or request; an output unit for verifying and outputting the information; a DB for registering information including a spatial location; information input means for inputting information including a desired spatial location; DB registration means for registering inputted information in the DB; request input means for inputting a request including a desired spatial condition; DB retrieving means for selecting information from the DB in response to an inputted request; information output means for outputting selected information; and location optimization means for representing a data in a smaller size by combining less unit zones when at least either the spatial location or the spatial condition is inputted.

An information management method of registering information in a DB, in which a space is pre-divided into a plurality of unit zones and re-divided into at least another plurality of unit zones, comprises the steps of inputting information including a desired spatial location by an information provider; optimizing location by combining less unit zones and representing a data in a smaller size when the spatial location is inputted; and registering inputted information in the DB.

An information management method of outputting information in a DB, in which a space is re-provided into a plurality of unit zones and re-divided into at least another plurality of unit zones, and information including a spatial location is pre-registered in the DB, comprises the steps of inputting a request including a desired spatial condition by a information recipient; optimizing location by combining less unit zones and representing a data in a smaller size when the spatial condition is inputted; retrieving information in the DB in response to an inputted request; and outputting selected information.

An information management method of registering and outputting information in a DB, in which a space is pre-divided into a plurality of unit zones and re-divided into at least another plurality of unit zones, comprises the steps of inputting information including a desired spatial location by an information provider; registering inputted information in the DB; inputting a request including a desired spatial condition by an information recipient; retrieving information in the DB in response to an inputted request; outputting selected information; and optimizing location by combining less unit zones and representing a data in a smaller size when at least either the spatial location or the spatial condition is inputted.

An information management program enabling information to be registered in a DB of a computer and enabling registered information to be selected, in which a space is pre-divided into a plurality of unit zones and the space is re-divided into at least another plurality of unit zones, is used as DB registration means for registering inputted information in the DB; DB retrieving means for selecting information in the DB in response to an inputted request; and location optimization means for combining less unit zones and representing a data in a smaller size when at least either a spatial location or a spatial condition is inputted. Since the information management program is installed in a predetermined computer by being stored in, for example, flexible disks (FD) or compact disks (CD) or by being distributed through communication networks such as the Internet, a corresponding computer is used as an information management device according to the present invention.

At least a part of each means in the information management system or the information management device according to the present invention is provided as a computer readable program.

The communication network is, for example, the Internet, and each of the host computers and terminals, includes a communication unit connected to the communication network. The host computer operates as a WEB server, and each terminal includes a WEB browser to use the service provided by the WEB server.

The host computer and the DB are not limited as one (1), respectively. That is, each of the host computer and the DB can be divided into two (2) or more to be connected to the communication networks. Location information of other external host computers on networks is registered in at least one host computer, and the external host computers are connected one after another by being connected to the host computer in each terminal. In contrast, each terminal can be a host computer, i.e., an information management device, by applying to and registering in the host computer. The number of host computers can be flexibly increased or decreased.

In the information management system according to the present invention, each terminal can be a host computer, i.e., an information management device, without any absolute host computer. At least a computer for managing location information of each terminal on the communication network is provided, and any subsequent systems are expandable spontaneously.

The information basically consists of an information content and an information location. The spatial location denotes the information location, for example, spatial points such as stores etc. and spatial lines such as road networks, railroad networks etc. Spatial planes such as the aggregation of routes including roads and railroads along which people can move by walking or using cars and trains can be also inputted.

The information can be, for example, advertisement information of stores. The information management system according to the present invention analyzes areas such as half-an-hour territory or one-hour territory according to the transportation conditions, more specifically, required time for each traffic line, thereby securing a spatial territory centered around the store. Accordingly, the spatial location can be registered with the information of the store.

The information can be, for example, information of delivery services and, in this case, the information provider is a delivery service businessman and, more specifically, a delivery lunch shop or delivery pizza house. A spatial location is a service territory and, more specifically, a territory being provided with the delivery service. The spatial location can be registered with the information of the store.

The information can be, for example, information of itinerary for a one-day tour and the information is a plan presented by a travel agency or a plan by ordinary information providers everywhere. The information of the itinerary includes, for example, a starting point, a destination, a travel route and a menu of meals, all of which can be retrieved.

The information can be, for example, information of distribution of animals, plans, dialects and customs, and the information can be registered related to dates after research or verification by ordinary information providers or researchers in a wide range. For example, in a conventional dialect dictionary, a spatial location of each dialect used to be only described roughly by expressing such as “used in XX region” and, furthermore, the historical change of the spatial location where the dialect is used is also recorded roughly.

The information can be, for example, information of distribution of mineral resources or ruins, and after ordinary information providers or researchers in a wide range research and verify, the information is registered.

The request basically consists of a request content and a request location. The spatial condition means the request location, for example, spatial points such as locations of information providers, etc., and spatial lines such as road networks, railroad networks etc. Spatial planes such as the aggregation of routes including roads and railroads along which people can move by walking or using cars and trains can be also inputted.

The request can be, for example, a request for information provided by a delivery service operator, and an information recipient can order an information provider, i.e., the deliver service operator, to provide the delivery service and he can be a user of the delivery service after receiving the information.

The request can be, for example, a request for information of volunteer groups. Inputting a request for a desired location area, an information recipient can receive the information of the volunteer groups where he can participate on weekends or the volunteer groups holding activities or inviting donations in the area where he requests, thereby joining and donating an appropriate group.

The request can be, for example, a request for information regarding any location being not spatially stable. For example, a portrait painter appearing at a tourist resort only on weekends has in advance registered in a DB all the information except for the spatial location of the tourist resorts, etc. At the time point when he secures a place for his work after arriving at his desired business places like tourist resorts, he accesses to a DB from a portable terminal and transmits identification information registered in the portable terminal. He also transmits location information as obtained through in the GSP apparatus included in the portable terminal and cuts off the communications. Thereby, it is possible to inform his clients that the ‘portrait painter’ will be working at the resort until the portable terminal accesses to the DB or until a predetermined time. An information recipient inputs the ‘portrait painter’ in the request content and inputs his desired area for visit on weekends in the request location by dragging a mouse, thereby obtaining the information of the portrait painter on business in the desired area. The information recipient can refer to samples of pictures of the painter, and he can visit where the painter works after confirming that the samples are of his desired painting style.

A space is pre-divided into a plurality of unit zones and the space is further re-divided into at least another plurality of unit zones. For example, provided are a unit zone chart and a unit zone DB consisting of two (2) or more map layers in which land or sea is divided into unit zones such as cities, streets and residence numbers. If the unit zones are partially separated by rivers or structures, the corresponding unit zone are re-divided. One unit zone classified by streets is represented, by combining a plurality of unit zones classified by residence numbers; and one unit zone classified by cities is represented, by combining a plurality of unit zones by streets.

For the unit zone chart and the unit zone DB, provided are two or more unit zone charts and two or more unit zone DBs which are not related to each other. For example, there are provided the unit zone chart and the unit zone DB including one or two or more layers divided by administrative districts, and the other unit zone chart and the other unit zone DB including one ore two or more layers divided by predetermined extension units and predetermined width units along the lines like roads, railroads, etc. As another example, there are one unit zone chart and one unit zone DB including one or two or more layers by administrative districts and the other unit zone chart and the other unit zone DB including one or two or more layers by postal management territories.

The unit zone is technically expressed as a ‘polygon’, however, there are a line zone in which one or two or more are combined for the means for securing at least spatial territories; or a unit zone or a unit zone DB which is expressed by points. The line zone are, for example, road sections divided by kilo post units and railroad blocks divided by rail stations; the points are, for example, intersections or railroad stations.

The means or conditions for securing the spatial territories are, for example, the means like roads, railroads, navigation routes, air routes; and the conditions like allowable quantity, service schedule or required time of the number of lanes and relay bases (e.g., railroad stations), which are described usually as ‘traffic conditions’ in this application.

In the information management system according to the present invention, information input prompting means or information input prompting step prompts an information provider to input information content by outputting an information content input screen in a terminal, and it prompts an information location to be inputted by outputting an information location input screen, so that the information inputted through information input means or information input step from the terminal is stored in a memory for some time.

In the information management device according to the present invention, information input prompting means or information input prompting step prompts an information content to be inputted by outputting an information content input screen in an output unit such as a display, and it prompts an information location to be inputted by outputting an information location input screen. In the information input means or information input step, the information is inputted by using the input unit such as a mouse.

The information location input screen enables a referential chart to be outputted to easily input a desired information location; enables the desired information location to be inputted using a mouse, etc.; and enables the information location to be partly deleted and to be easily and specifically represented. Further, each table is outputted in a referential DB such as address DB, zip code DB and information type DB so that a desired address, zip code or type of information can be easily inputted, and desired data can be selected using the mouse.

In the information management system according to the present invention, request input prompting means or request input prompting step prompts a request content be inputted by outputting a request content input screen in a terminal, and it prompts a request location to be inputted by outputting a request location input screen, so that the request inputted in the terminal of the request input means or the request input step is stored in a memory for some time.

In the information management device according to the present invention, request input prompting means or request input prompting step prompts a request content to be inputted by outputting the request content input screen in an output unit such as a display, and it prompts the request location to be inputted by outputting the request location input screen. In the request input prompting means and the request input prompting step, the request is inputted using the input unit such as a mouse.

In the request location input screen, a referential chart is outputted to make it easy to input a desired request location, the desired request location is inputted using the mouse, the request location is easily and specifically represented by being partly deleted. Further, each table is outputted in a referential DB such as address DB, zip code DB and information type DB so that a desired address, zip code or type of information is easily inputted, and desired data is selected using the mouse.

In the location optimization means or the location optimization step, when at least any one of a spatial location and a spatial condition, namely, an information location and a request location, is inputted, less unit zones are combined and a data is represented in a smaller size. Specifically, when at least any one of the information location and the request location is inputted and it includes one city, it is represented as one record; if it further includes one street, it is represented as another record; and if it further includes one residence number, it is represented as the other record. The data size is analyzed and represented to be combined at a minimum.

For example, if there are one unit zone chart and one unit zone DB by a city unit and the other unit zone chart and the other unit zone DB by a predetermined expansion unit of roads, and if at least any one of an information location and a request location is inputted in the location optimization means or the location optimization step, the optimization is performed by combining less unit zone by cities and the unit zone by roads. Although a part of selected unit zone by cities and a part of selected unit zone by roads may be spatially overlapped, such an overlapping does not make any matters in DB registration means or DB retrieving means.

In order to prevent one information location or one request location from being registered or conditionally inputted in a great number of records without any limitation, the location optimization means or the location optimization step limits the number of records which are registered as for the information location or request location on a predetermined condition. Specifically, for example, at least any one of the number of records or areas which forms the information location or the request location is limited. As a further example, in order to represent one information location or one request location regardless of the number of layers prepared in the unit zone chart, each unit zone is selectable in the maximum three (3) layers.

In the location optimization means or the location optimization step, if it is impossible to optimize at least any one of the information location and the request location by exactly corresponding to each other, the optimization is similarly performed by allowing an error range within a few percentage of the total area. The number of records which represent at least any one of the information location and the request location is limited as the maximum “n”, and even though the records exactly correspond, the optimization is similarly performed to limit the number of the records within “n”.

In the location optimization means or the location optimization step, if the unit zones with respect to at least any one of the information location and the request location should be analyzed and represented so that less unit zones be combined and the data is organized in a smaller size, specific process methods are not limited to one.

The information inputted in the DB registration means or the DB registration step is registered in the information DB, and specifically, the information content is registered in the information content DB, and the information location is inputted in the information location DB, respectively.

At least a part of information inputted in the DB registration means or the DB registration step is registered in the information DB, and specifically, the request content is registered in the information content DB, and the request location is registered in the information location DB, respectively. The registered request is opened to other information providers so that they can read.

In order to prevent information from being maliciously registered, the information management system, the information management device and the information management method according to the present invention comprises an information provisional DB for provisionally registering inputted information; DB provisional registration means or DB provisional registration step for provisionally registering the inputted information; DB registration authorization decision means or DB registration authorization decision step for authorizing or rejecting information as provisionally registered based on a predetermined rule; information DB for normally registering information as authorized for reading; and DB registration means for normally registering the information as authorized.

Further, the request as inputted in the DB retrieving means or the DB retrieving step is associated with the information DB, specifically, if the request content is inputted, the request content is associated with the information content DB, and if the request location is inputted, it is associated with the information location. The information as selected in the information output means or the information output step is outputted to a predetermined device such as a terminal.

The DB retrieving means according to the present invention is characterized in that, if the request location is represented as a plurality of records by the location optimization means, each record is associated with each information location. Information as selected as each being associated is outputted in a predetermined device after removing any overlap as the case may be.

The information content of the information are outputted by referring to the referential DB such as address DB, zip code DB, information type DB, etc. In the information output means or the information output step, the referential chart can be outputted overlapping one another to represent the information location on a map. Each table is further outputted to be again inputted, a desired data is selected using a mouse.

If the request is registered, a corresponding request is associated with the information DB in the DB retrieving means or the DB retrieving step after checking a regular time by a timer. The selected information (referred to as a “recommendation information” in this application) in the information output means or the information output step is outputted to a predetermined apparatus, for example, a junction apparatus such as a mail server. As for the information as pre-registered in the information output means or the information output step, information (referred as to as a “relevant information” in this application) which is relevant or similar to a corresponding information is selected and is outputted to a predetermined device. The relevant information is considered as informative to an information provider, for example, the information of a delivery pizza house as pre-registered is the information of the other competing companies, and it is further the information of the territories where there are many or a few competing delivery pizza houses or where there is a high chance of business being not corresponded by all delivery pizza houses.

In the information management system, the information management device and the information management method according to the present invention, at least a part of the conditions of means for having a spatial range in each unit zone is pre-registered, and the information is selected based on the conditions corresponding to the unit zone, which corresponds to the spatial condition as inputted in the DB retrieving means or the DB retrieving step.

Specifically, in each unit zone, there are recorded the conditions of a plurality of railroads, train stations, roads, communication networks, distance from exchanges and/or arrival time, and the information is selected by selecting railroads and roads in the order of advantageous distance and/or arrival time as the unit zone corresponding to the spatial conditions as inputted.

In the information management system, the information management device and the information management method according to the present invention, there are provided user registration means or user registration step for registering at least any one of an information provider and an information recipient as a user; identification information is given to a registered user; there are provided user charge means or user charge step for charging to the registered user; and a charge for use is imposed through a monetary facility server. The registered user is prompted to input the identification information in order to identify an individual in editing the information of registration being finished. The user registration means prompts a user to input specifically an user information on the information registration screen, together with the information registration means when first registering the information. Further, there are differences with respect to the quality/quantity of the information which an information recipient as pre-registered and an information recipient as not registered can receive. The charge for use is automatically paid from the bank account of each user per regular term.

In the user charge means or the user charge step, for example, the charge for use is decided according to the frequency of use; further for example, the charge for use is decided according to the data size of the information as registered. Specifically, for example, the charge for use is decided according to the area of the information location as registered. Thereby, it is possible to control massive information from being registered by information providers without any limitation.

In the information management system, the information management device and the information management method according to the present invention, there are provided information content inquiry means or information content inquiry step for inquiring and replying about the information content with respect to at least a part of the outputted information between an information recipient and an information provider; there are further provided contract relation means or contract relation step in which an information recipient sends a request for an estimate to one or two or more information providers with respect to at least a part of the information as outputted and in which the information providers reply to the information recipient in response to the corresponding request for the estimate; there are further provided contract mediation means or contract mediation step for mediating a contract to be concluded between the information recipient and the information provider with respect to at least a part of the information as outputted; and there are further provided contract evaluation means or contract evaluation step in which the results as estimated with respect to the outcome based on the contract by the information provider are registered for any additional reading.

### BRIEF DESCRIPTION OF THE DRAWINGS

To above objects, features and advantages of the present invention will become more apparent from the following detailed description when taken in conjunction with the accompanying drawings, in which:

FIG. 1 is a configuration diagram of an information management system according to Embodiment 1 and a block diagram of main parts of an information management device;

FIG. 2 is a configuration example of a referential DB according to Embodiment 1;

FIG. 3 is a configuration example of a referential chart, a unit zone chart and a unit zone DB according to Embodiment 1;

FIG. 4 is a configuration example of an information content DB and an information location DB consisting an information DB according to Embodiment 1;

FIG. 5 is a process flow chart illustrating information input prompting means and request input prompting means according to Embodiment 1;

FIG. 6 is a process flow chart illustrating DB registration means according Embodiment 1;

FIG. 7 is an output example of an input screen from a terminal according to Embodiment 1;

FIG. 8 is a process flow chart illustrating location optimization means according to Embodiment 1;

FIG. 9 is a process flow chart illustrating an optimization process A in the location optimization means according to Embodiment 1;

FIG. 10 is a process flow chart illustrating an optimization process B in the location optimization means according to Embodiment 1;

FIG. 11 is a process flow chart illustrating DB registration means according to Embodiment 1;

FIG. 12 is a process flow chart illustrating an information editing process according to Embodiment 1;

FIG. 13 is a process flow chart illustrating information output means according to Embodiment 1;

FIG. 14 is an implementation example illustrating a location retrieval of DB retrieving means according to Embodiment 1;

FIG. 15 is an output example of an information output screen to be outputted to a terminal by information output means according to Embodiment 1;

FIG. 16 is a configuration diagram of an information management system and a block diagram of main part of an information management device according to Embodiment 2;

FIG. 17 is a configuration example of a unit zone chart and a unit zone DB according to Embodiment 2;

FIG. 18 is a configuration diagram of an information management system and a block diagram of an information management device according to Embodiment 3;

FIG. 19 is a configuration example of a referential chart, a unit zone chart, a unit zone DB and an information DB according to Embodiment 3;

FIG. 20 is a process flow chart illustrating a location optimization process and DB registration means according to Embodiment 3;

FIG. 21 is a process flow chart illustrating location optimization, DB retrieving means and information output means according to Embodiment 3;

FIG. 22 is an output example of recommendation information as outputted into a predetermined device by the information output means according to Embodiment 3;

FIG. 23 is an output example of relevant information as outputted into a predetermined device according to Embodiment 3;

FIG. 24 is a configuration diagram of an information management system according to Embodiment 4;

FIG. 25 is a configuration diagram of an information management system according to Embodiment 5;

FIG. 26 is a configuration diagram of an information management and a block diagram of main parts of an information management device;

FIG. 27 is a block diagram illustrating history combination means for combining registration history of the information DB in Embodiment 6;

FIG. 28 is a block diagram illustrating information synchronous means for synchronizing the information DB in Embodiment 6;

FIG. 29 is a block diagram illustrating main part synchronous means for synchronizing information management main parts in Embodiment 6;

FIG. 30 is a block diagram illustrating main part update means for updating the information management main parts provided in the information management device by receiving a request for update from another terminal in Embodiment 6;

FIG. 31 is a block diagram illustrating main part provisional update means for provisionally updating the information management main parts by another terminal in Embodiment 6;

FIG. 32 is a configuration diagram of an information management system and a block diagram illustrating main parts in the information management system in Embodiment 7;

FIG. 33 is an output example of an information content input screen being outputted to a predetermined device by information input prompting means in Embodiment 7;

FIG. 34 is an output example of an information location input screen being outputted to a predetermined device by the information input prompting means in Embodiment 7;

FIG. 35 is an output example of request input screen being outputted to a predetermined device by request input prompting means in Embodiment 7;

FIG. 36 is an output example of an information output screen being outputted to a predetermined device by information output means in Embodiment 7;

FIG. 37 is a configuration example of information DB, user DB, inquiry DB, contract DB, charge DB and Open DB in Embodiment 7;

FIG. 38 is a process flow chart illustrating user charge means in Embodiment 7;

FIG. 39 is a process flow chart illustrating information content inquiry means, contract mediation means and contract evaluation means in Embodiment 7;

FIG. 40 is an output example of a map indicating main parts of an information DB and a spatial location as registered in Embodiment 8;

FIG. 41 is an output example of a map indicating main parts of an information DB and a spatial location as registered in Embodiment 9;

FIG. 42 is an output example of a map indicating main parts of an information DB and a spatial location as registered in Embodiment 10;

FIG. 43 is an output example of a map indicating main parts of an information DB and a spatial location as registered in Embodiment 11;

FIG. 44 is a block diagram illustrating a configuration of a conventional information management system corresponding to the service advertisement as provided with a spatial territory;

FIG. 45 is a configuration diagram of main parts in each of information management systems according to a first scheme and a second scheme, in which a spatial location is processed in a vector format so that a spatially distorted area is designated; and

FIG. 45 is a configuration diagram of main parts in each of information management systems according to a first scheme and a second scheme, in which a spatial location is processed in a text format so that a spatially distorted area is designated.

### DETAILED DESCRIPTION OF PREFERRED EMBODIMENTS

Preferred embodiments of the present invention are described in detail with reference to the accompanying drawings. Although each device illustrated in each embodiment is not illustrated to describe the main parts of the present invention, it appropriately comprises each part provided in a wildly known computer. Each part is a communication unit such as a modem to connect to a communication network like Internet, an input unit such as a key board, an output unit such as a display, a memory unit to record data for some time, a record unit such as a hard disk to record the data, and an operation unit such as a CPU to execute various operations. If predetermined purposes are achieved in the technique of the present invention, specific process methods are not defined as one.

Basically, in each embodiment, data as inputted by an information provider is described as information, the information basically consists of an information content and an information location; data as inputted by an information recipient to receive the information is described as a request, the request basically consists of a request content and a request location. Further, in some embodiments, since both of the information and the request are registered in a DB, the information location and the request location to be inputted are jointly described as an input location when explaining some figures, the information content and the request content to be inputted are jointly described as an input content. When both of the information and the request are registered in the DB, both are jointly described as the information, specifically, the information content and the information location.

To indicate that the information location and the request location are spatial data, the claims of the present invention describe the information location as the spatial location and the request location as the spatial condition.

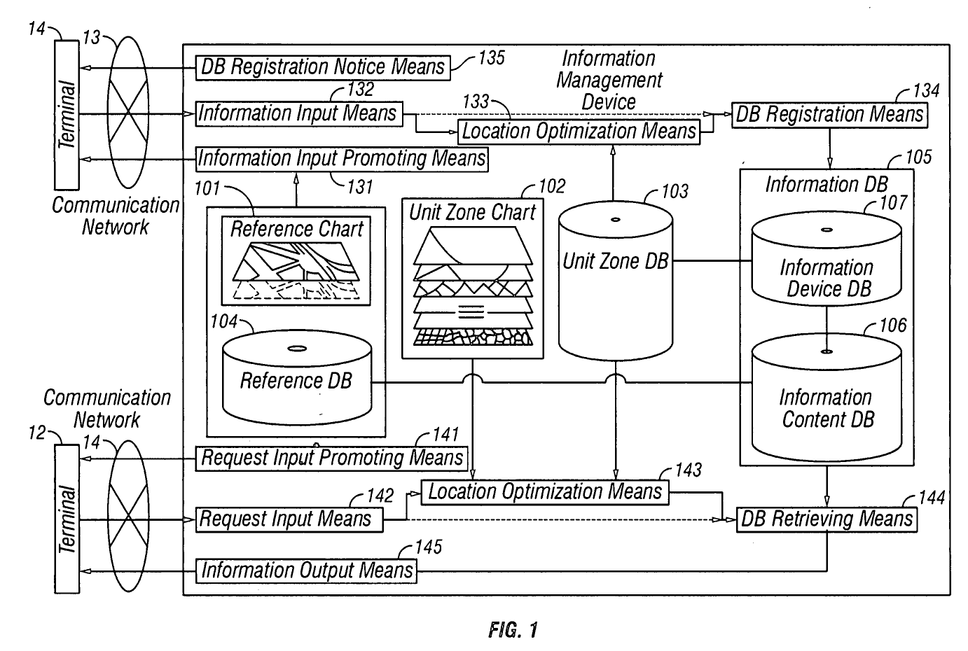

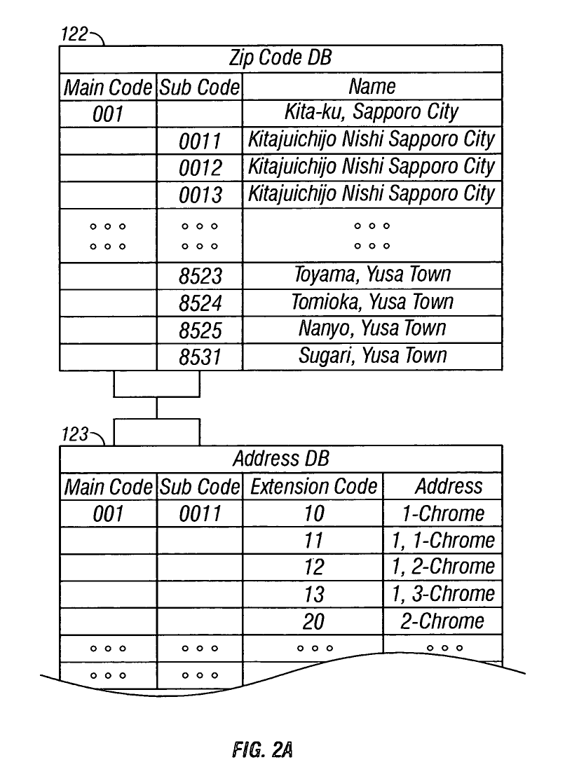

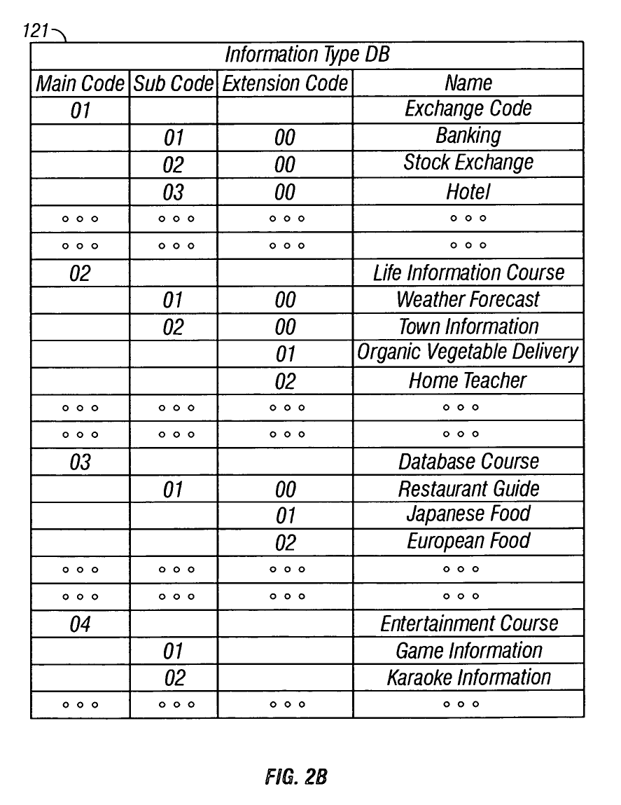

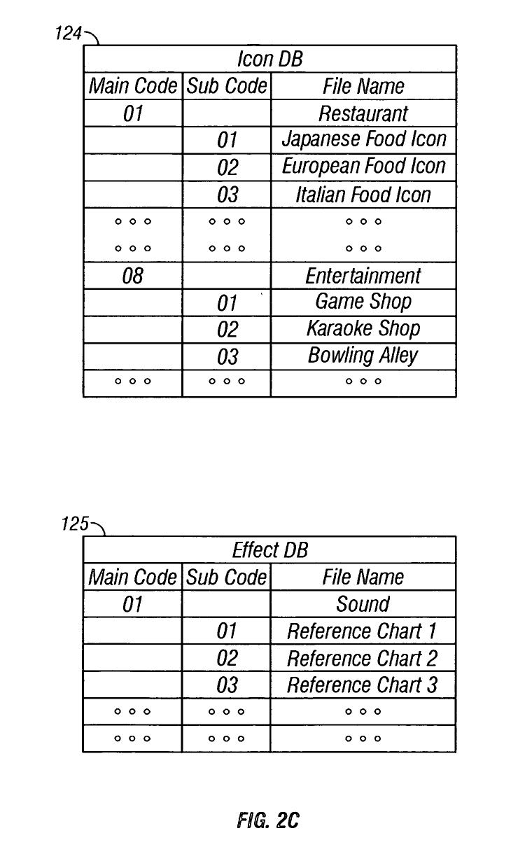

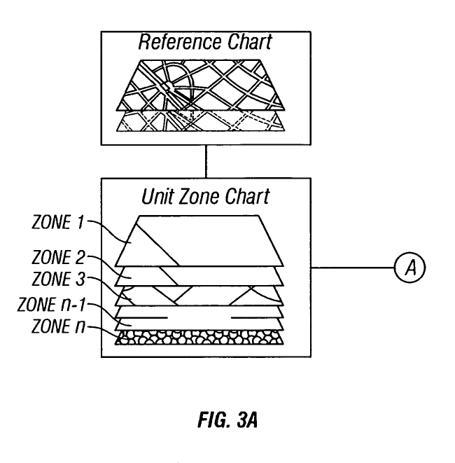

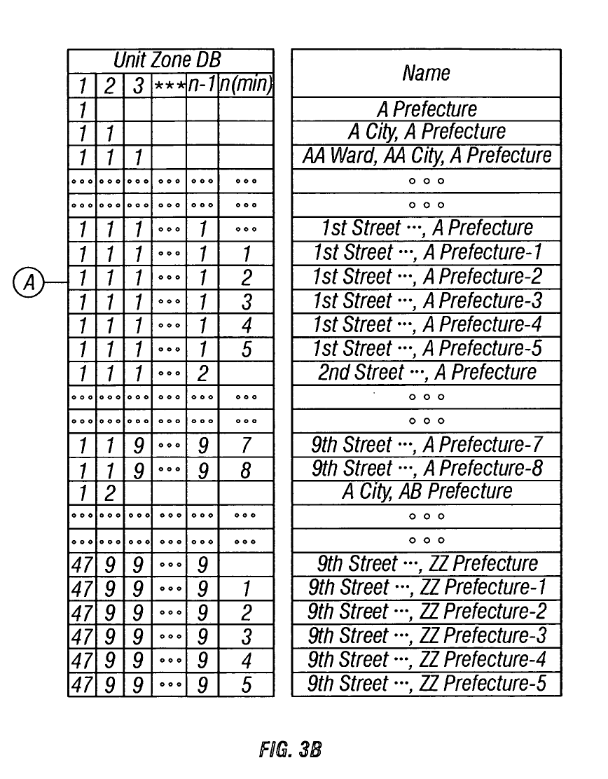

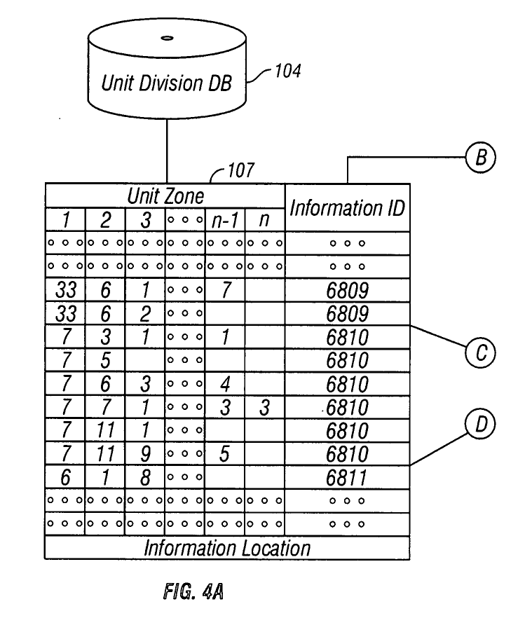

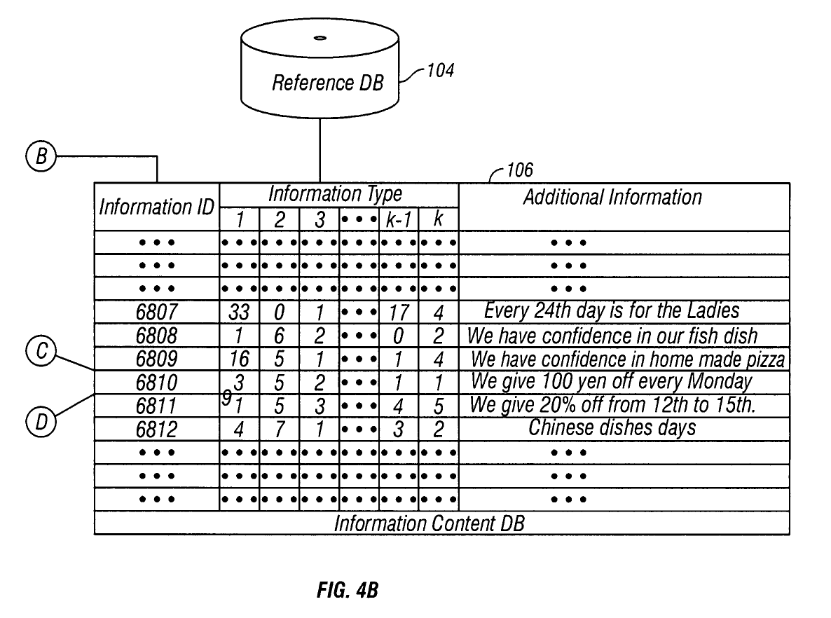

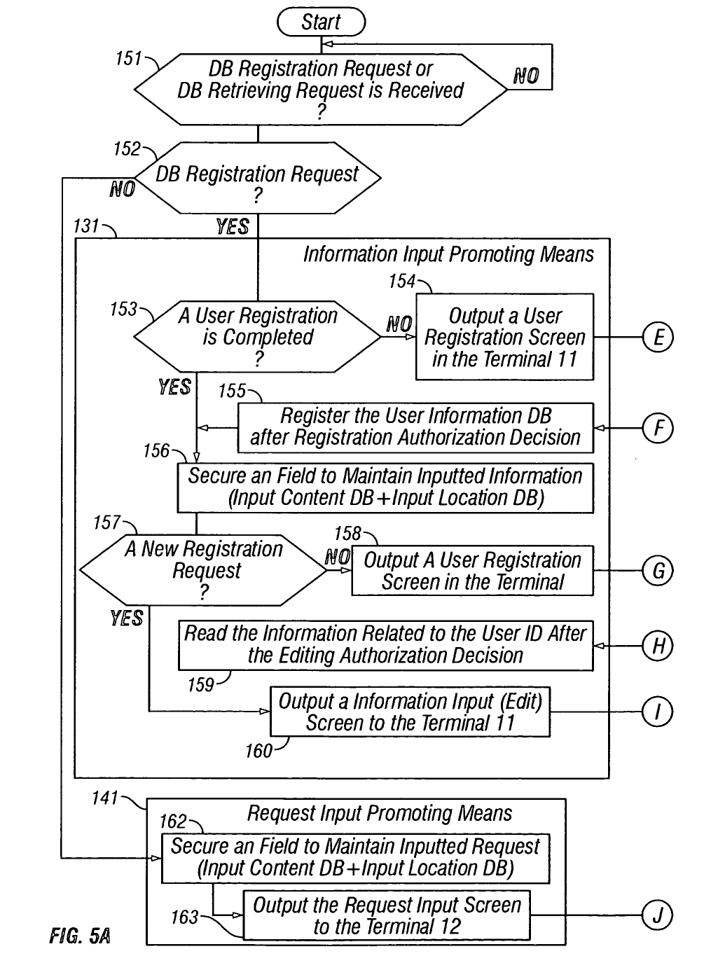

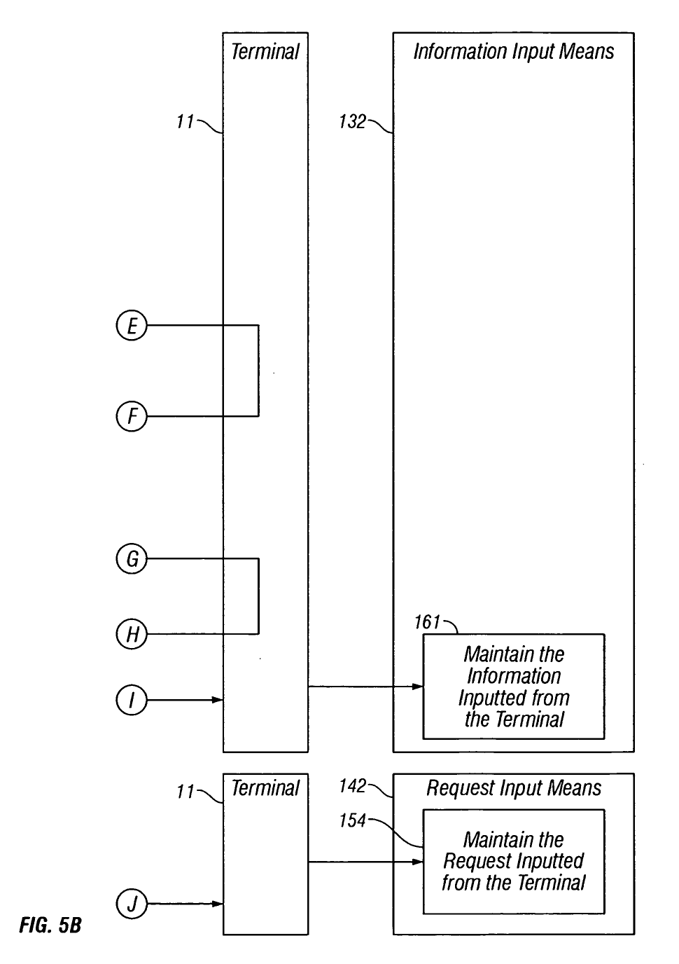

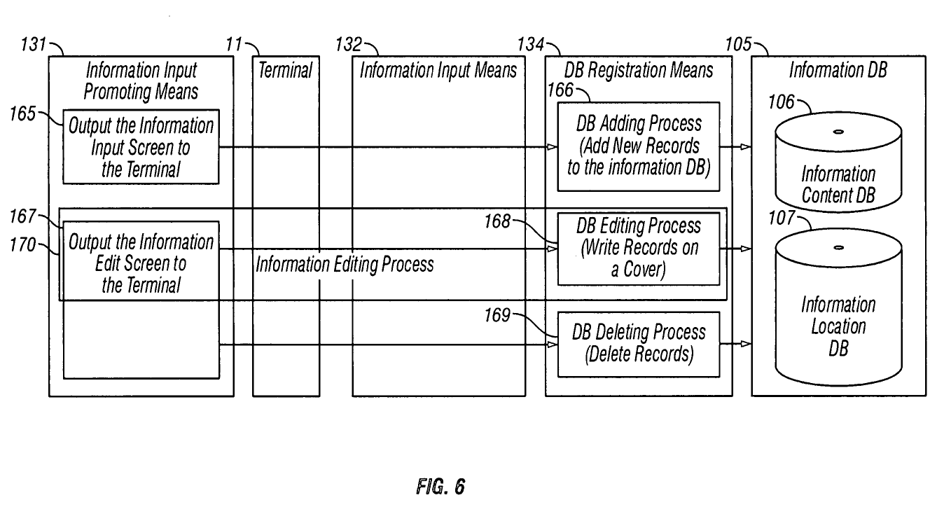

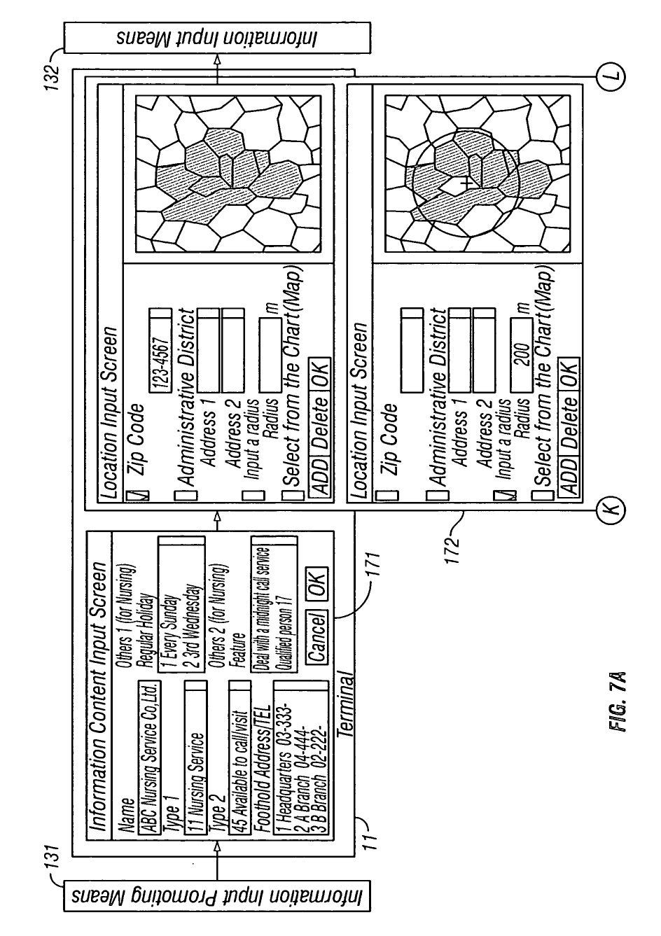

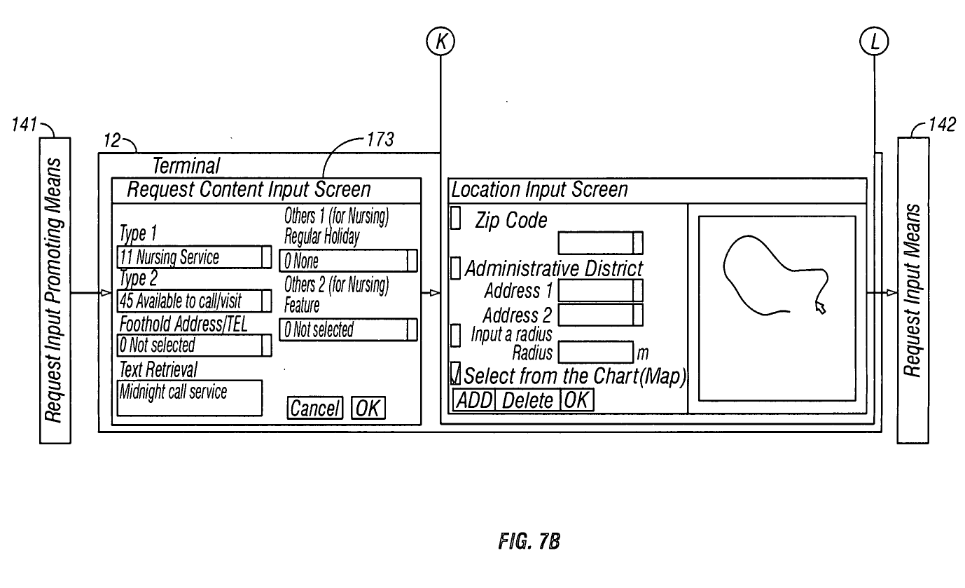

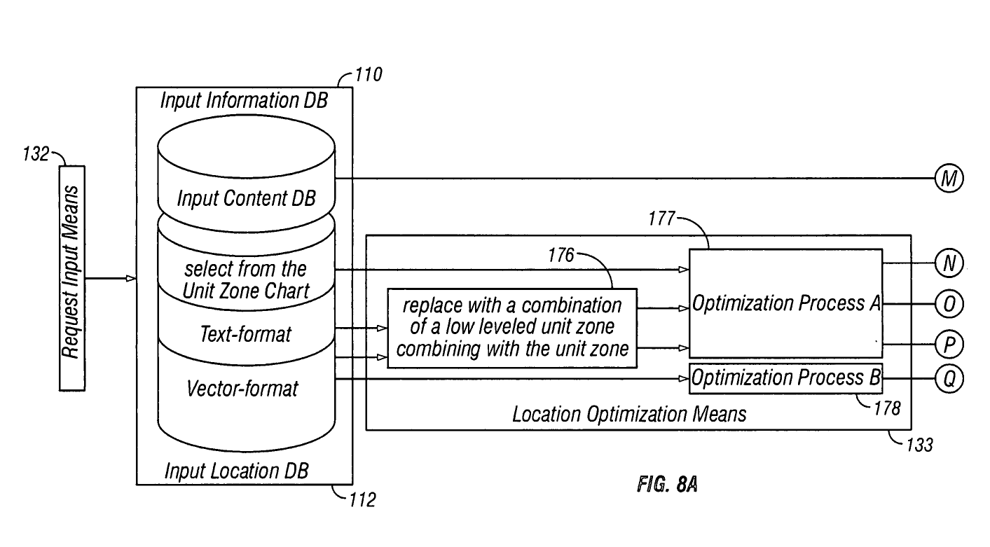

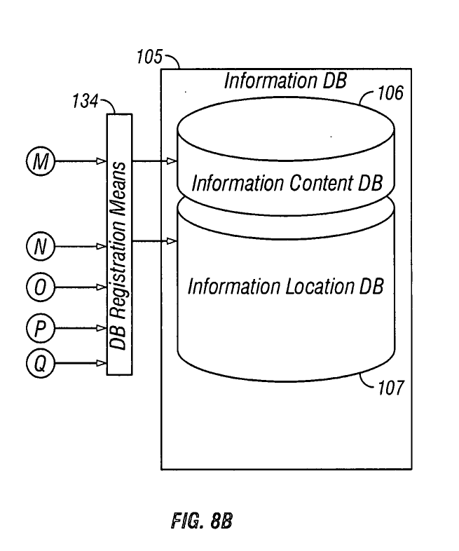

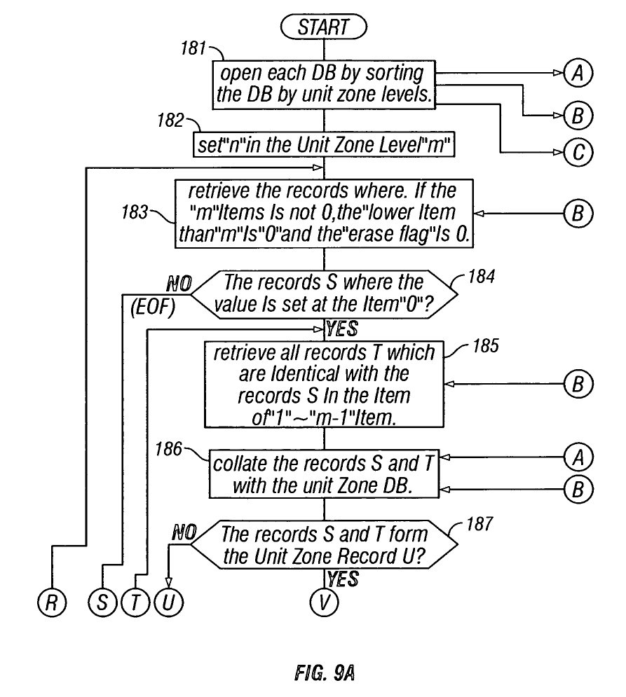

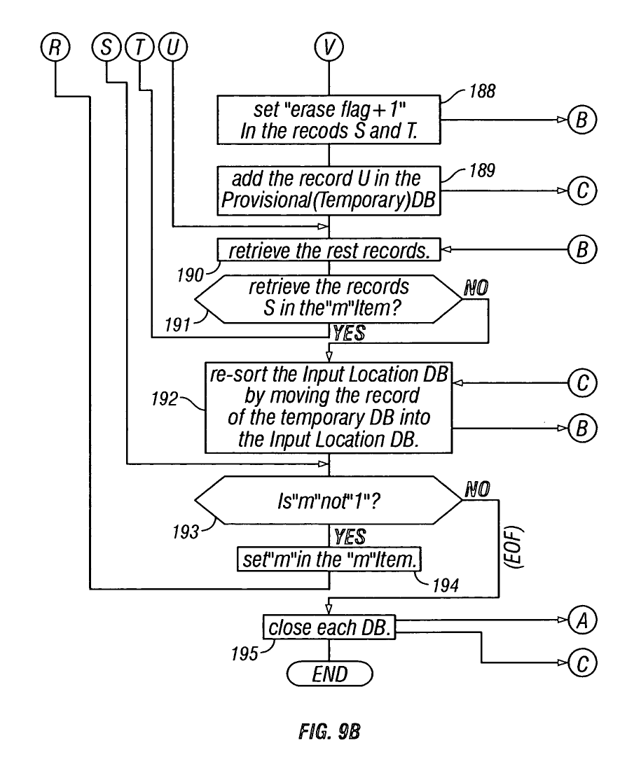

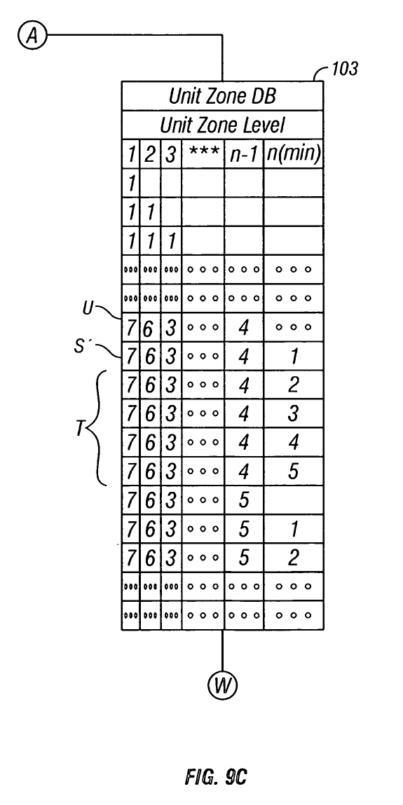

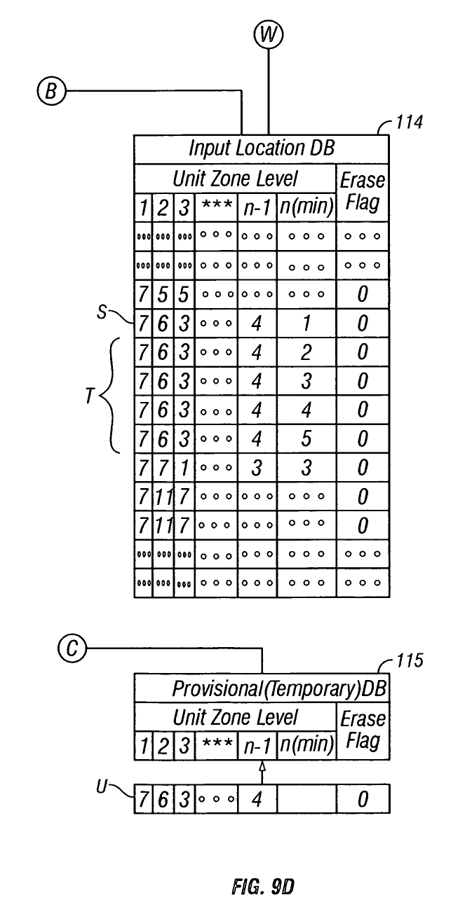

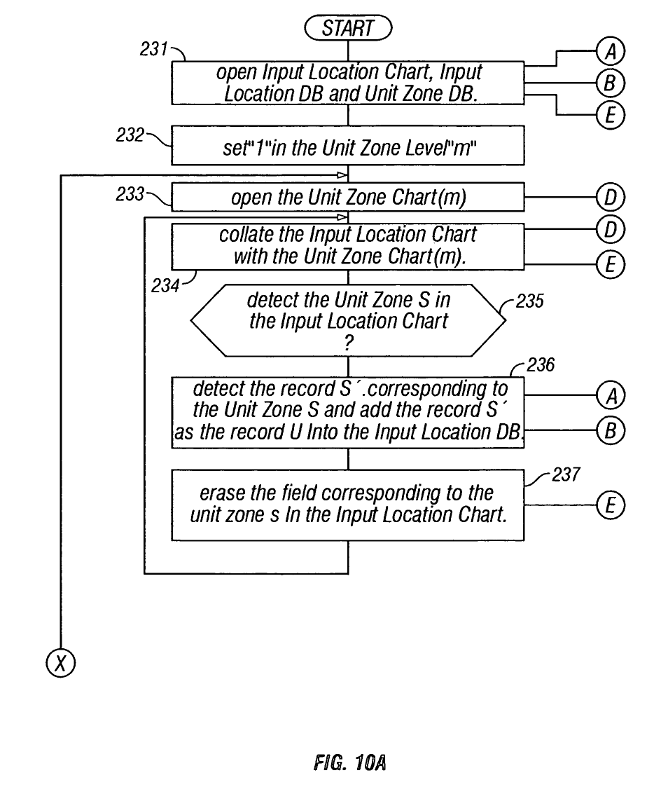

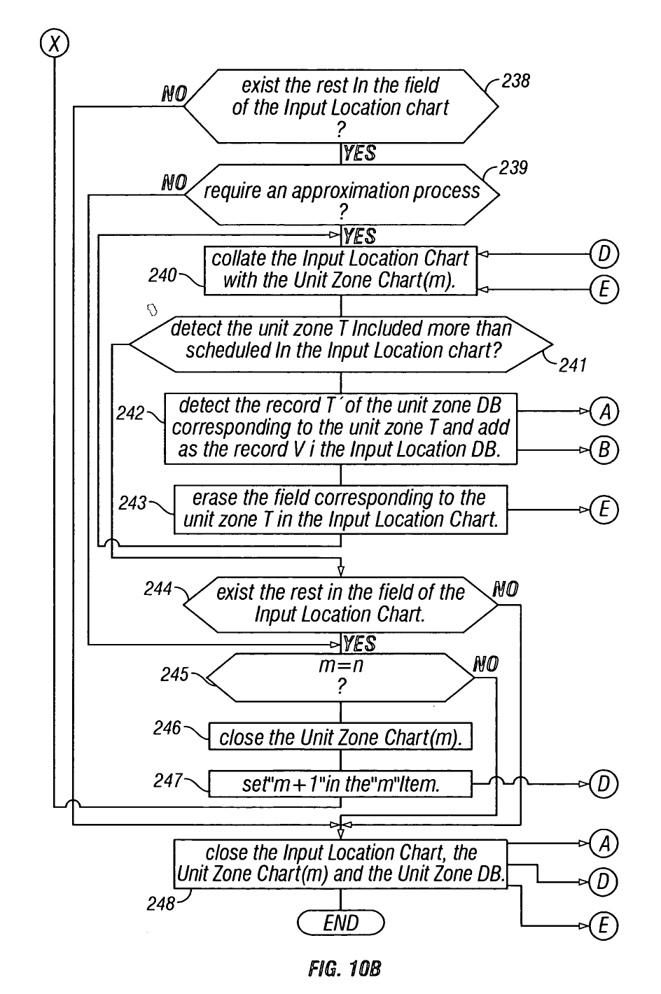

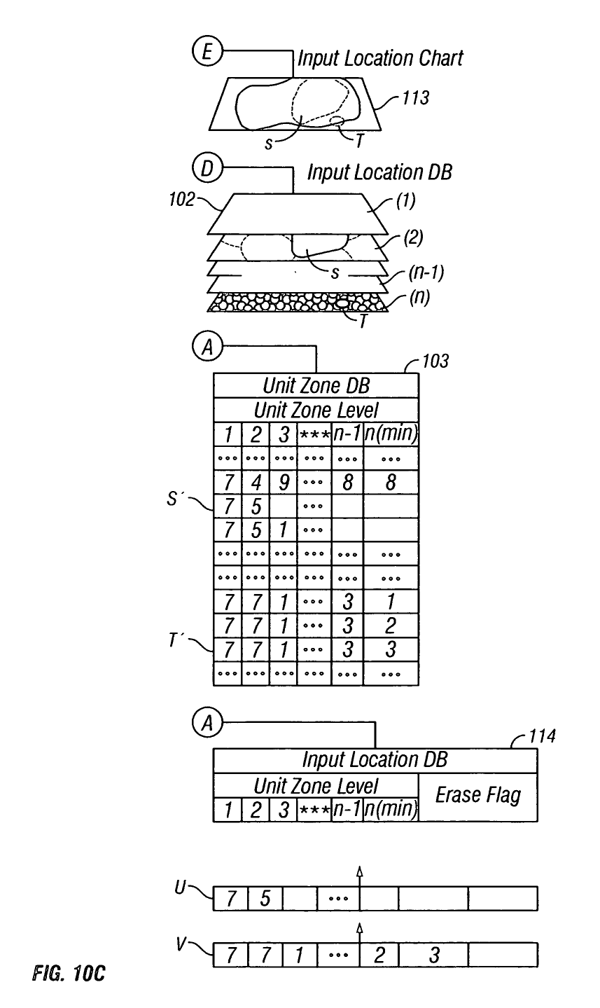

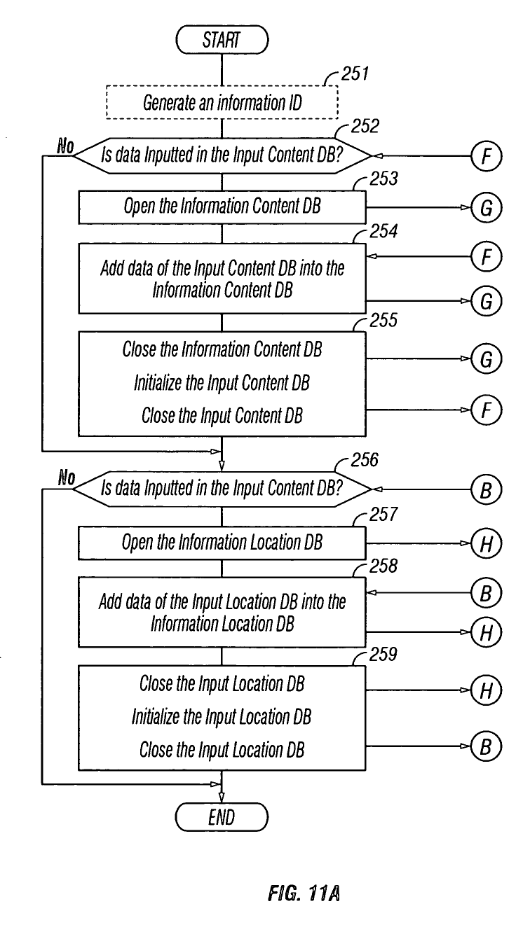

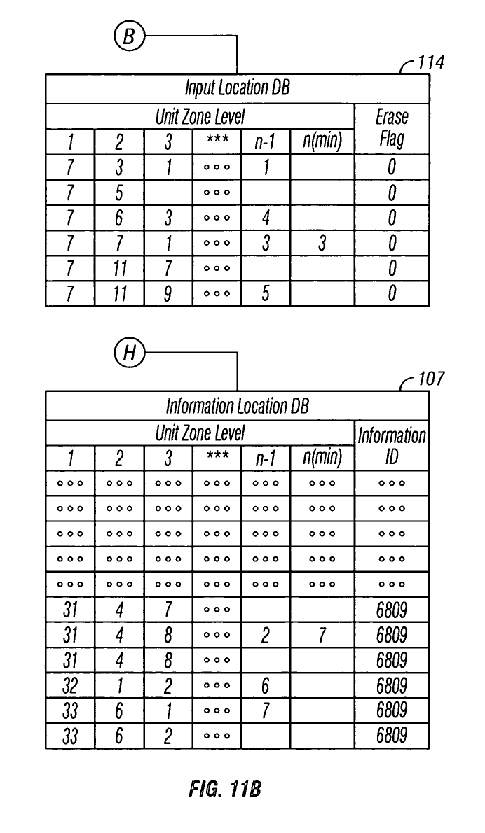

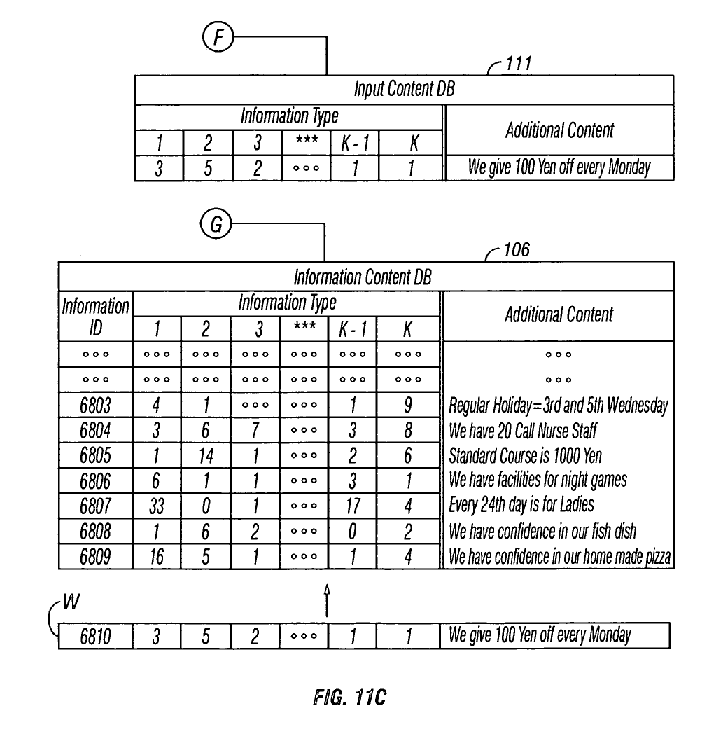

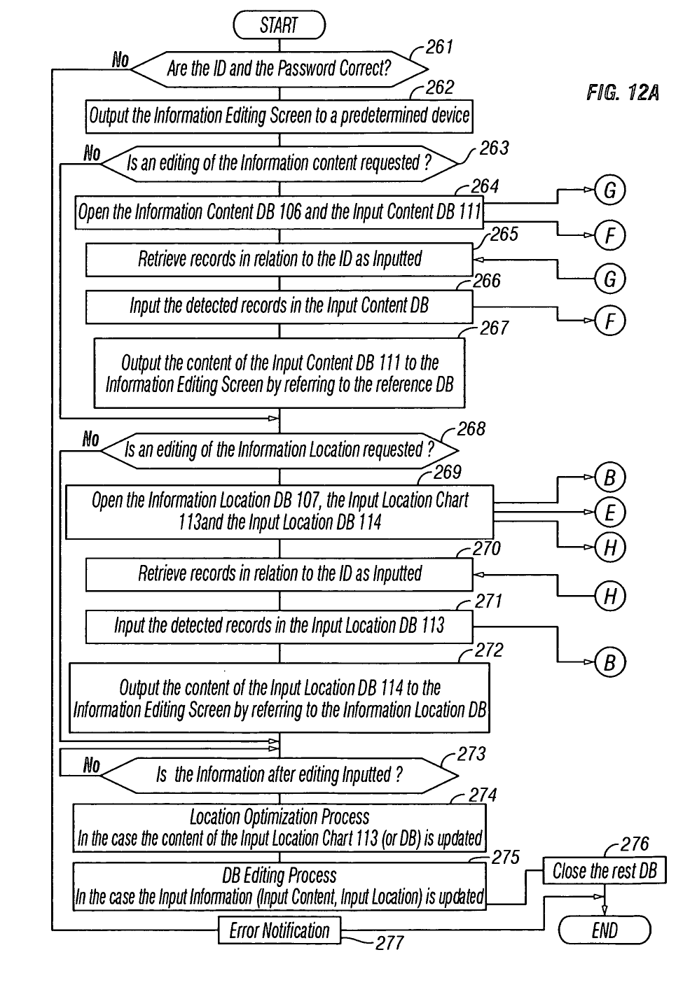

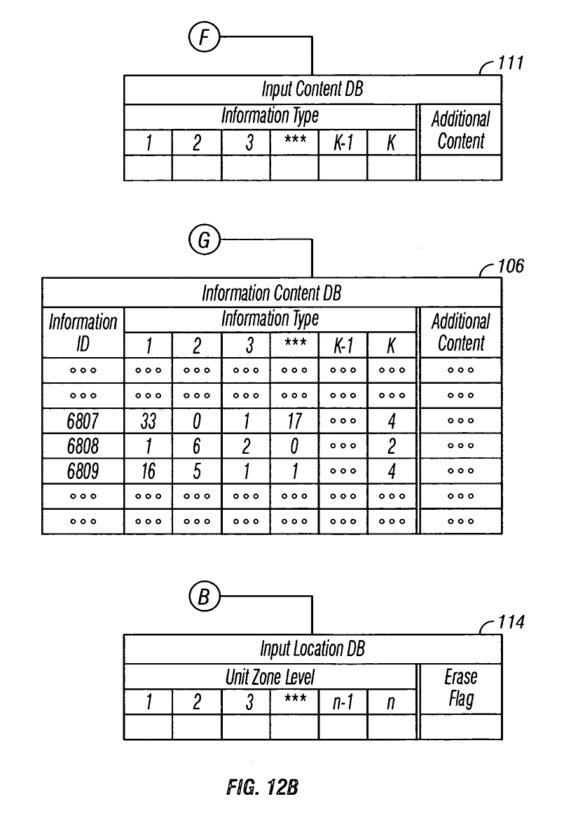

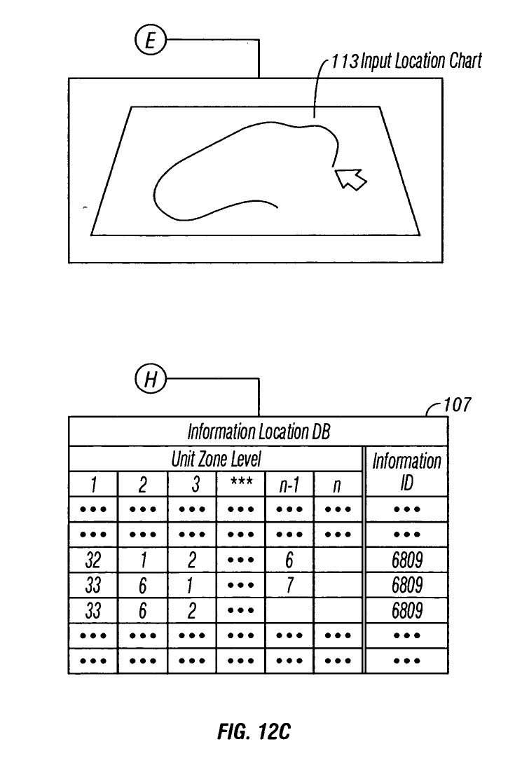

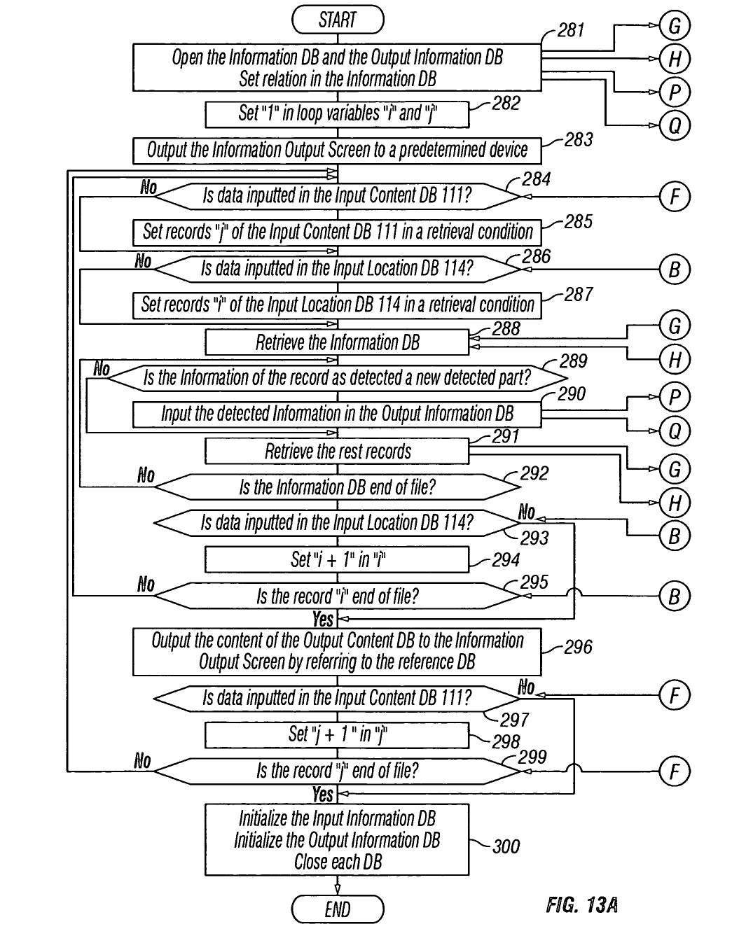

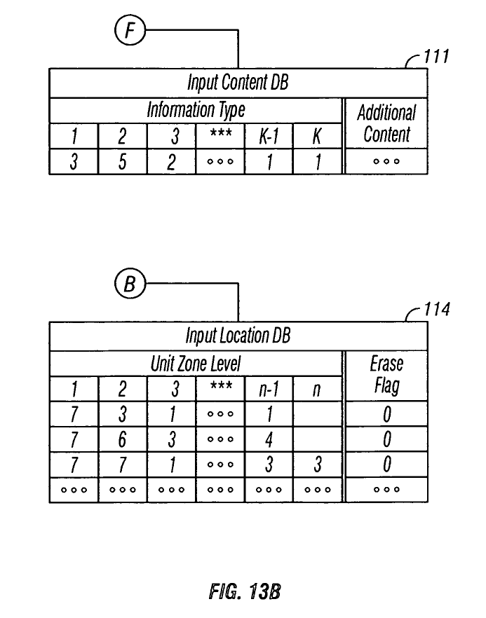

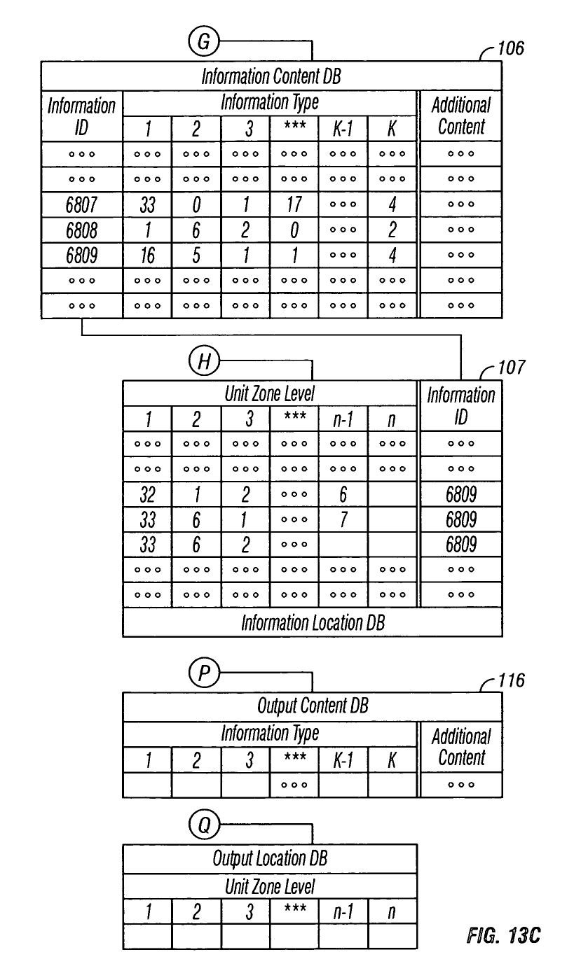

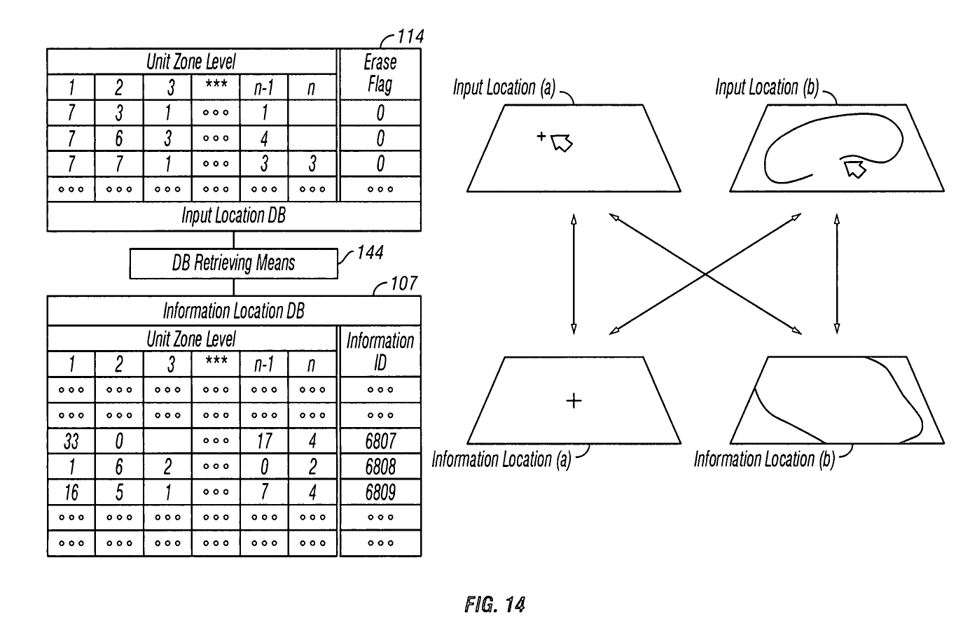

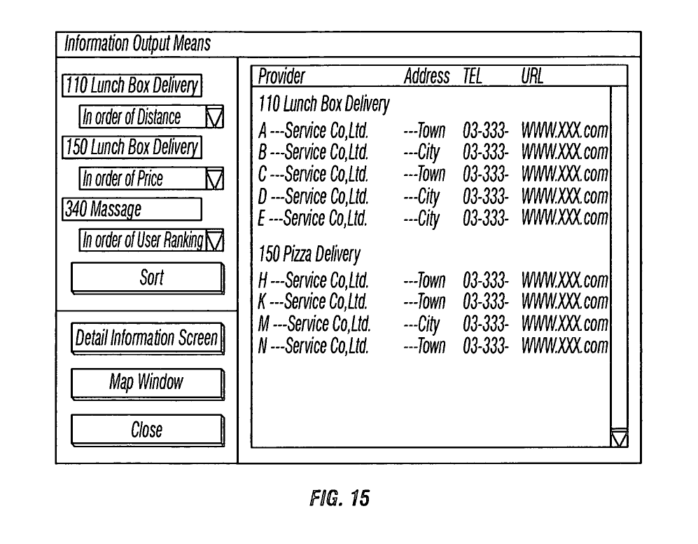

A first embodiment according to the present invention is described below: FIG. 1 is a block diagram illustrating an information chart of an information management system and the main parts of an information management device in Embodiment 1; FIG. 2 is an example illustrating a configuration of a reference DB in Embodiment 1; FIG. 3 is an example illustrating a reference chart, a unit zone chart and a unit zone DB in Embodiment 1; FIG. 4 is an example illustrating an information content DB and an information location DB consisting an information DB in Embodiment 1; FIG. 5 is a process flow chart illustrating information input prompting means and request input prompting means in Embodiment 1; FIG. 6 is a process flow chart illustrating DB registration means in Embodiment 1; FIG. 7 is an example illustrating an output from each input screen to a terminal in Embodiment 1; FIG. 8 is a process flow chart illustrating location optimization means in Embodiment 1; FIG. 9 is a process flow chart illustrating optimization process A of the location optimization means in Embodiment 1; FIG. 10 is a process flow chart illustrating optimization process B of the location optimization means in Embodiment 1; FIG. 11 is a process flow chart illustrating DB registration means in Embodiment 1; FIG. 12 is a process flow chart illustrating information editing process in Embodiment 1; FIG. 13 is a process flow chart illustrating information output means in Embodiment 1; FIG. 14 is an implementation example illustrating a location retrieval of DB retrieving means in Embodiment 1; and FIG. 15 is an example illustrating an output from an information output screen to a terminal by the information output means in Embodiment 1.

As shown in FIG. 1, an information management device 10 is opened being connected to a communication network 13, 14 by a communication unit not shown in the figure; a terminal 11 of an information provider and a terminal 12 of an information recipient are connected to the communication network 13, 14 by the communication unit not shown in the figure and these are accessed to the information management device 10. The information management device 10 is operated by an operator not shown in the figure, for example, at least a part of an information input by the information provider or an information output to the information recipient is mediated. The information management device 10 comprises a reference chart 101 to be referred by the information provider and the information recipient; a unit zone chart 102 and a unit zone DB 103 in which a space is divided into a plurality of unit zones; a reference DB 104 such as a DB classifying information by types; and an information DB 105 including an information content DB 106 to register an information content of the inputted information and an information location DB 107 to register an information location.

In the information management device 10, information input means 131 prompts information to be inputted by outputting an information input screen to the terminal 11, upon a request from the terminal 11. The information input screen represents at least a part of the reference chart 101 so that the information location can be easily inputted.

When the information is inputted, information input means 132 maintains the information in a memory etc. for some time; when the information location is inputted, location optimization means 133 optimizes the information location; DB registration means 134 registers the information content and the information location with an information content DB 106 and an information location DB 107, respectively; and DB registration notice means 135 notifies a completion of registration to the terminal 11 and it simultaneously decides an identification information for the registered information and notifies it. Then, the information provider inputs a corresponding identification information and updates the information of which registration is completed.

Further, in the information management device 10, request input prompting means prompts a request to be inputted by outputting an request input screen to the terminal 12, upon a request from the terminal 12. The request input screen represents at least a part of the reference chart 101 so that the request location can be easily inputted.

When the request is inputted, request input means 141 maintains the request in a memory etc. for some time; when the request location is inputted, location optimization means 143 optimizes the request location; DB retrieving means 144 combines the request with the information DB 105 and selects the information; and information output means 145 outputs the information to the terminal 12.

In FIG. 2, the reference DB comprises an information type DB 121 to register the types of information; a zip code DB 122 to register a catalog of zip codes; an address DB 123 to register a catalog of address; an icon DB 124 to register icons which can be represented in the reference chart; and an effect DB 125 to register sound corresponding to each situation. Each of the DBs is associated with the information DB 105.

In FIG. 3, the reference chart 101 comprises one or two or more layers; the unit zone chart 102 comprises layers such as zone₁, zone₂, - - - zoneₙ according to unit zone levels; the unit zone Db 103 comprises fields of the levels such as zone₁, zone₂, - - - zoneₙ like the unit zone chart 102. The table on the right side of the unit zone chart 102 represents the relation between each unit zone and a conventional administration system and it is not substantially registered in the unit zone DB.

In FIG. 4, the information DB comprises the information content DB 106 and the information location DB 107. The information content DB 106 further comprises information ID fields which are related to the information location DB 107; information type fields related to the reference DB 104, wherein the number of the information type fields is “k” and the number of the referenced DBs is “K”; and additional content fields which are to be inputted in a text format. The information location 107 further comprises information ID fields; and unit zone level fields related to the unit zone DB 103, wherein the number of unit zones level fields is “n”. For example, in the information which is registered as “information ID=6810” in the figure, the information content is registered as record 1 in the information content DB 106, and the information location is registered as record 6 in the information location DB 107.

In FIG. 5, if a DB registration request is received from the terminal 11 and a DB retrieving element is received in the terminal 12 (151), specifically, if the request is the DB registration request (152), the information input prompting means 131 prompts the information input to the terminal 11; and if the request is the DB retrieving request (152), the request input prompting means 141 prompts the request input to the terminal 12.

If a user registration is not completed (153), that is, if the DB registration request is made by not inputting the identification information, information input prompt means 131 prompts user information to be inputted by outputting a user registration screen in the terminal 11 (154); and if the user information is inputted, after registration authorization decision, the user information is registered a user information DB not shown in the figure (155). The terminal 11 secures an area to maintain inputted information, that is, an area for an input content DB and an input location DB, on a memory (156). If it is not a new registration request for information (157), the identification information and password input are prompted by outputting the user identification screen to the terminal 11 (158); if the identification information and password is inputted, after the editing authorization decision, the information reads being related to the identification information in the information DB 105. If it is a new registration request for information (157), the information reading the information input screen is represented; and if an editing request, the information reading the information editing screen is represented and outputted to the terminal 11. If the information is inputted in the terminal 11, the information input means 132 maintains the information content of the corresponding information in the input content DB and the information location in the input location DB (161).

The request input prompt means 141 secures a field to maintain the request as inputted in the terminal 12, that is, the field of the input content DB and the input location DB, on the memory (162) and outputs the request input screen to the terminal 12 (163). If the request is inputted in the terminal 12, the request input means 142 maintains the request content of the corresponding request in the input content DB and the request location in the input location DB (164).

In FIG. 6, the DB registration means 134 comprises a DB adding process 166 for adding records to the information DB 105; a DB editing process 168 for writing records on a cover; and a DB deleting process 169 for deleting records. A new registration process as not shown in the figure is accomplished by performing the DB adding process 166 after the information input prompt means 131 outputs the information input screen to the terminal 11 (165); an information editing process 170 is accomplished by performing the DB editing process 168 after the information input prompt means 131 outputs the information editing screen to the terminal 11 (167); an information deleting process as not shown in the figure is accomplished by performing the DB deleting process 169 after the information input prompt means 131 outputs the information editing screen to the terminal 11 (167).

In FIG. 7, the information input prompt means 131 enables an information content input screen 171 and an information location input screen 172 to be outputted in the display of the terminal 11 and enables the information content and the information location to be inputted in the terminal 11; and the request input prompt means 141 enables a request content input screen 173 and a request location input screen to be outputted in the display of the terminal 12 and enables the request content and the request location to be inputted in the terminal 12. The request location input screen is not shown in the figure since it is almost similar to the information location input screen 172.

In FIG. 8, location optimization means 133 optimizes an input location DB 112 of an input information DB 110 maintained in the memory by the information input means 132, that is, an input content DB111 and an input location DB 112; and the input information DB 110, the input content DB 111 and the input location DB 112 are registered in the information DB 105, the information content DB 106 and the information location DB 107 by the DB registration means 134, respectively.

The input location DB 112 is inputted in three kinds of data formats by the information input means 132, specifically, a unit zone format selected in the unit zone chart; a text format such as zip code and address; and a vector format inputted using a mouse. If the input location DB 112 is inputted in the unit zone format, the location optimization means 133 performs optimization process A 177; if inputted in the text format, it performs optimization process A 117 after combining with the unit zone chart and replacing with a combination of a low leveled unit zone (176); and if inputted in the vector format, it performs optimization process A 177 or B 178 after selecting one of two ways mentioned above, specifically, combining with the unit zone chart and replacing with a combination of a low leveled unit zone (176). The location optimization means 133 does not need to provide all of the above-mentioned processes, for example, in case that the input location DB 112 is inputted in the vector format, it has at least one of two way processes.

Whenever any input location being not optimized is inputted, the location optimization means 133 performs optimization. For example, if _OK_button is selected while the process that a desired information location is inputted on the information location input screen by an information provider, the location optimization means 133 performs optimization. Thereby, it is possible to check the information location at the time point when the _OK_ button is selected

Although the figure illustrates the main parts of the location optimization means 133 for optimizing the information location, the main parts of the location optimization means 143 for optimizing main parts are not illustrated because those are the same.

In FIG. 9, the optimization process A uses the unit zone DB 103 and the input location DB 114 and sometimes the input location DB 115. As the input location DB 114 re-makes an index whenever records are added, it takes time to process. Therefore, an erase flag item in the input location DB 114 is used to provisionally erase records, and the input location DB 115 is used to maintain, for some time, one or two or more records to be inputted in the input location DB 114.

The optimization process A opens each DB by sorting the DB by unit zone levels (181); sets a lowest level “n” of the unit zone levels at a variable “m” of the unit zone levels (182); and retrieves the records where, if the “m” item is not 0, the “lower item than m” is “0” and the “erase pug” is “0” (183).

If the records S where the value is set at the item “m” (184) are retrieved, all records T which are identical with the records S in the item of “1˜m−1” item are retrieved (185); the records S and T are combined with the unit zone DB 103 (186); and if the records S and T form the unit zone records U with “m−1” level, “erase flag=1” is set in the records S and T (188), the records U are added in DB 115 for some time, the rest records are retrieved (190); and each process after 185 is repeated while retrieving the records S in the “m” item (191).

The input location DB is re-sorted by moving the records of the DB 115 into the input location DB 114 for some time (192); while the variable “m” is not 1 (193), “m−1” is set in the variable “m” (194); each process after 183 is repeated; and if “m” becomes 1, each DB is closed (195), thereby ending the process.

In FIG. 10, the optimization process B uses an input location chart 113 and an input location DB 114 in which the input location is inputted in the vector format, the unit zone chart 102 and the unit zone DB 103.

The optimization process B opens the input location chart 113, the input location DB 114 and the unit zone DB 103 (231); sets the unit zone level variable “m” as “1” (232); opens the layer “m” of the unit zone chart 102 (233); combines the input location chart 113 with the layer “m” (234); detects the record S′ corresponding to the unit zone S while detecting the unit zone S included in the input location chart 113; adds the record S′ as the record U into the input location DB 114 (236); and erases the field corresponding to the unit zone S in the input location of the input location chart 113 (237) and then each process after 234 is repeated.

While the rest exists in the field of the input location chart 113 and an approximation process is required (239), the input location chart 113 is combined with the layer “m” (240); while the unit zone T included more than scheduled in the input location chart 113 is detected (241); the records T′ of the unit zone DB 103 corresponding to the unit zone T is detected and added as the records V in the input location DB 114 (242); the field corresponding to the unit zone T in the input location of the input location chart 113 is erased (243), and then each process after 240 is repeated. If the rest does not exist in the field of the input location chart 113 (238), each figure and each DB are closed (248), thereby ending the process.

While the rest records exist in the field of the input location chart 113 (244) and the variable “m” is not “n” (245), the layer “m” is closed (246), the variable “m” is set as “m+1” (247), each process after 233 is repeated; and if “m” is “1”, each figure and each DB is closed (248), thereby ending the process. Further, if the rest records do not exist in the field of the input location chart 113 (244), each figure and each DB is closed (248), thereby ending the process.

In FIG. 11, the DB registration means uses the input content DB 111 in which the input content is inputted, the input location DB 114 in which the input location is inputted, the information content DB 106 in which the information content is registered, and the information location DB 107 in which the information location is registered.

The DB registration means generates an information ID to associate the information contents DB 106 and the information location DB 107 (251) and it performs each process with respect to the input content and the input location.

If the input content is inputted in the input content DB 111 (252), the information content DB 106 is opened (253); date of the input content DB 111 are added into the information content DB 106 (254); then, the process is closed after closing the information content DB 106 and initializing the input content DB 111 (255).

If the input location is inputted in the input location DB 114 (256); the information location DB 107 is opened (257); all records of the input location DB 114 are added into the information location DB 107; then, the process is closed after closing the information location DB 107 and initializing the input location DB 114 (259).

In FIG. 12, the information editing process uses the input content DB 111 in which the input content is inputted, the input location chart 113 and the input location DB 114 in which the input location is inputted, the information content DB 106 in which the information content is registered, and the information location DB 107 in which the information location is registered.

In the information editing process, if the ID as inputted, namely, the identification information and the password, are correct (261), the information editing screen is outputted to a predetermined device (262). If the ID as inputted, namely, the identification information and the password, are not correct (261), an indication to reject the information editing process is notified (277), thereby ending the process.

If an editing of the information content is requested (263), the information content DB 106 and the input content DB 111 are opened (264); any records in relation to the identification information as inputted are retrieved (265); detected records are inputted in the input content DB 111 (266); and the content of the input content DB 111 is outputted to a predetermined column of the information editing screen by referring to the reference DB (267).

If an editing of the information location is requested (268), the information location DB 107, the input location chart 113 and the input location DB 114 are opened (269); all records in relation to the identification information as inputted are retrieved (270); all records as detected are inputted in the input location DB 114 (271); the information location is represented in the input location chart 113 by referring to the unit zone chart and the unit zone DB on the basis of the content of the input location DB 114 and it is outputted to a predetermined column of the information editing screen (272).

If the information after editing is inputted in the predetermined device (273) and the content of the input location chart 113 is updated, the location optimization process is performed (274); and if the input information, that is, at least any of the the input content and the input location is updated, the DB editing process is performed (275) and the process is closed by closing the rest DB (276).

In FIG. 13, the information output means uses the input content DB 111 in which the input content is inputted, the input location DB 114 in which the input location is inputted, the information content DB in which the information content is registered, the information location DB 107 in which the information location is inputted, the output content DB 116 in which the output content is inputted, and the output location DB 117 in which the output location is inputted.

The information output means opens the information DB, that is, the information content DB 106, the information location DB 107, the output content DB 116 and the output location DB 117 (281); it sets “1” in loop variables “i” and “j” (282); it outputs the information output screen to a predetermined device (283); if the input content is inputted in the input content DB 111 (252), it sets records j of the input content DB 111 in a retrieval condition (285); and if the input location is inputted in the input location DB 114 (286), it sets records “I” of the input location DB 114 in the retrieval condition (287), thereby retrieving the information DB (288).

Further, if the information of the record as detected is a new detected part (289), the detected information is inputted in the output information DB, that is, the output content DB 116 and the output location DB 117 (290), and the rest records are retrieved, and each process after 289 is repeated till EOF is detected in the information DB (292).

If the input exists in the input location DB 114, the variable “i” is set as “i+1” (294) and each process after step 284 is repeated until EOF is detected by retrieving records i in the input location DB 114 (295).

Further, the content of the output information DB is outputted to a predetermined column of the information output screen by referring to the reference DB (296); if the input exists in the input content DB 111 (297), the variable “j” is set as “j+1” (298); and each process after 284 is repeated till EOF is detected by retrieving records j in the input content DB (299). If no input exists in the input content DB (297) or if EOF is detected in the input content DB (299), the process is ended by initializing the input information DB and the output information DB and closing each DB.

In FIG. 14, the DB retrieving means retrieves each inputted record in input location 114 from the record having high unit zone level field value, by combining the input location inputted in the input location DB 114 with the information location inputted in the information location DB 107. The DB retrieving means further selects, in the information location DB 107, the records in which each record is identical with the value of the unit zone level field or in which each record represents a bigger location to cover the location represented by each record.

The input location is inputted by points as shown in the input location (a) or by areas as shown in the input location (b); the information location is registered by points as shown in the information location (a) or by areas as shown in the information location (b). If the input location and the information location are all inputted by points, these are changed to minimum unit zone including the corresponding points in the unit zone chart and the unit zone DB. For example, if the input location (a) is inputted and the information location (a) is selected in the information location DB, this is the case where each unit zone as replaced is the same.

In FIG. 15, in the information output screen, if two or more information is output, the corresponding information is re-displayed by changing the order as desired and selecting a comparison/exchange button; the details of the information as designated to the information recipient is displayed by selecting a detailed information display button; and the information location of the information as designated to the information recipient is mapped and displayed by selecting a map display button.

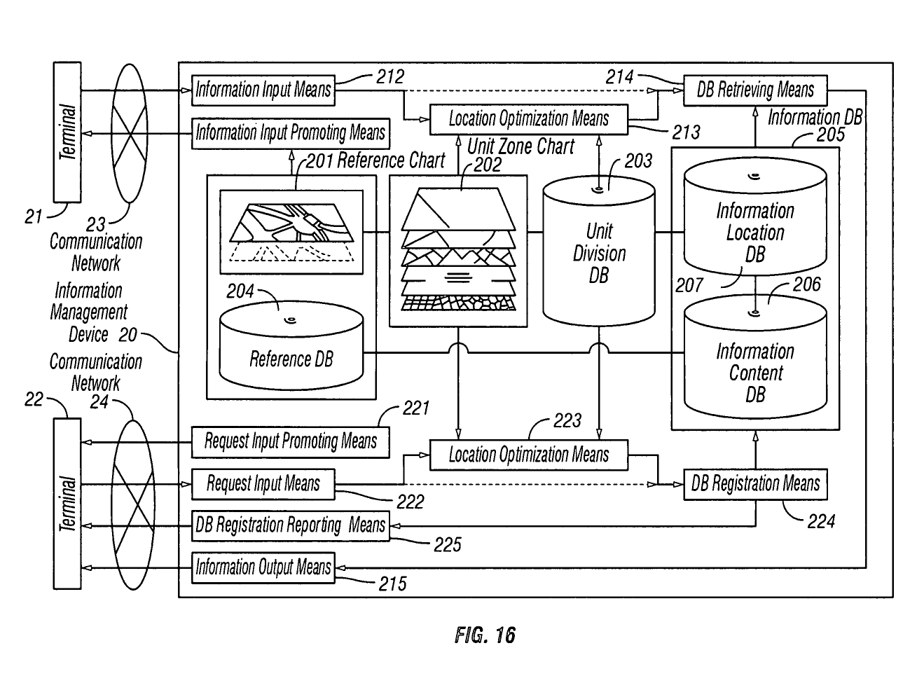

A second embodiment according to the present invention is described below: FIG. 16 is a block diagram illustrating a configuration of an information management system and the main parts of an information management device in Embodiment 2; and FIG. 17 is an example of configurations of a unit zone chart and a unit zone DB in Embodiment 2.

In FIG. 16, an information management device is opened being connected to a communication network 23, 24 by a communication unit not shown in the figure, a terminal 21 of an information provider and a terminal 22 of an information recipient are connected to the communication network 23, 24 by the communication unit not shown in the figure and these are accessed to the information management device 20. The information management device 20 comprises a reference chart 201 to be referred by the information provider and the information recipient; a unit zone chart 202 and a unit zone DB 203 in which a space is divided into a plurality of unit zones; a reference DB 204 such as a DB classifying information by types; and an information DB 205 including an information content DB 206 to the information content of the inputted information and an information location DB 207 to register the information location. Although the figure illustrates the communication network 23 and the communication network 24, it does not matter even if it may be one communication network.

In the information management device 20, if a request is made from the terminal 22, request input prompt means 221 prompts the request input by outputting a request input screen to the terminal 22. The request input screen represents at least a part of the reference chart 201 so that the request location is easily inputted.

If the request is inputted, request input means 222 maintains the request in a memory for some time; if the information location is inputted, location optimization means 233 optimizes the request location, DB registration means 224 registers a request content in the information content DB 206 and a request location in the information location DB 207; and DB registration notice means 225 notifies, to the terminal, that registrations is completed, simultaneously notifies a decision of its own identification information with respect to the request. Then, the information provider updates the registered request by inputting the corresponding identification information,

In the information management device 20, if a request is made from the terminal 21, information input prompt means 211 prompts the information input by outputting an information input screen to the terminal 21. The information input screen represents at least a part of the reference chart 201 so that the information location is easily inputted.

If information is inputted, information input means 212 maintains the information in a memory for some time; if information location is inputted, location optimization means 143 optimizes the information location; DB retrieving means 214 selects the request by combining the information with the information DB 205; and information output means 215 outputs the information to the terminal 22 which is a registration origin of the selected request.

In FIG. 17, the unit zone chart 202 and the unit zone DB 203, in which a space is three-dimensionally divided, are associated with each other. In this embodiment, the space has three levels like large, medium and small, each level being divided into a plurality of unit zones. Unit zone S1, S2 by the large classification in the unit zone chart 202 are indicated as S1, S2 in the unit zone DB 203, respectively; unit zone T1 by the middle classification in the unit zone chart 202 is indicated as T1 in the unit zone DB 203; and unit zone U1 by the small classification in the unit zone chart 202 is indicated as U1 in the unit zone data DB 203.

The unit zone chart and the unit zone DB being three-dimensionally divided are suitable to the purpose of managing, for example, weather information in the air, mineral information under the ground and fishery resources information. In this embodiment, although each unit zone is a cube, it is divided in a suitable form to manage the information by the atmosphere layers in the air, the geological layers in the ground and the fishing ground in the ocean.

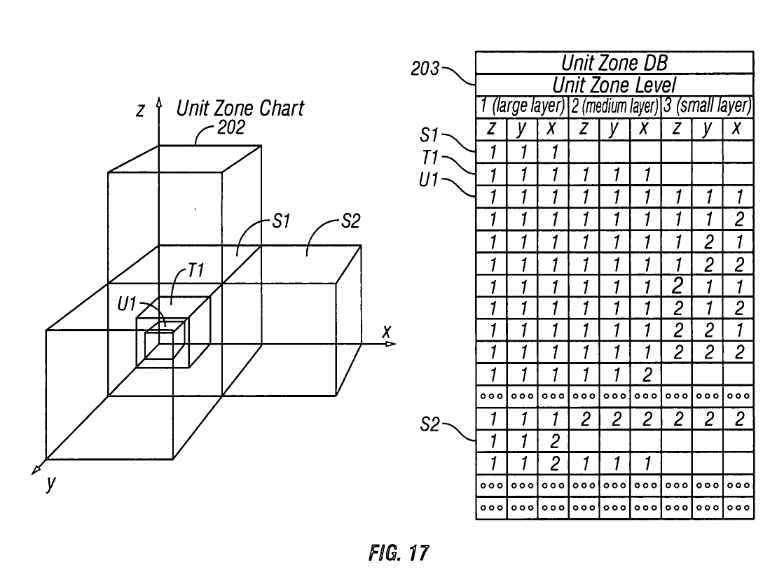

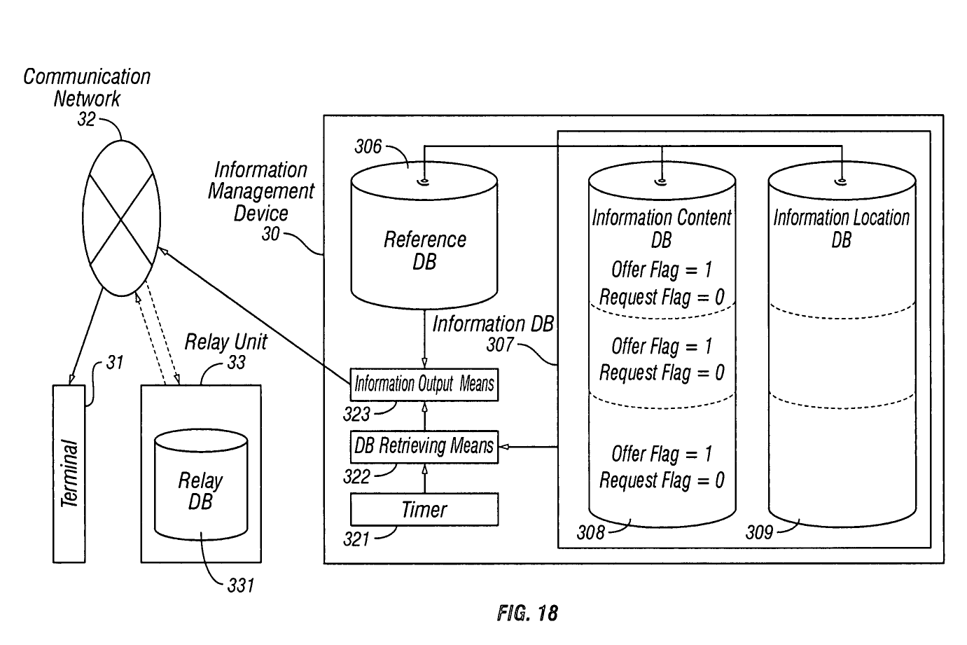

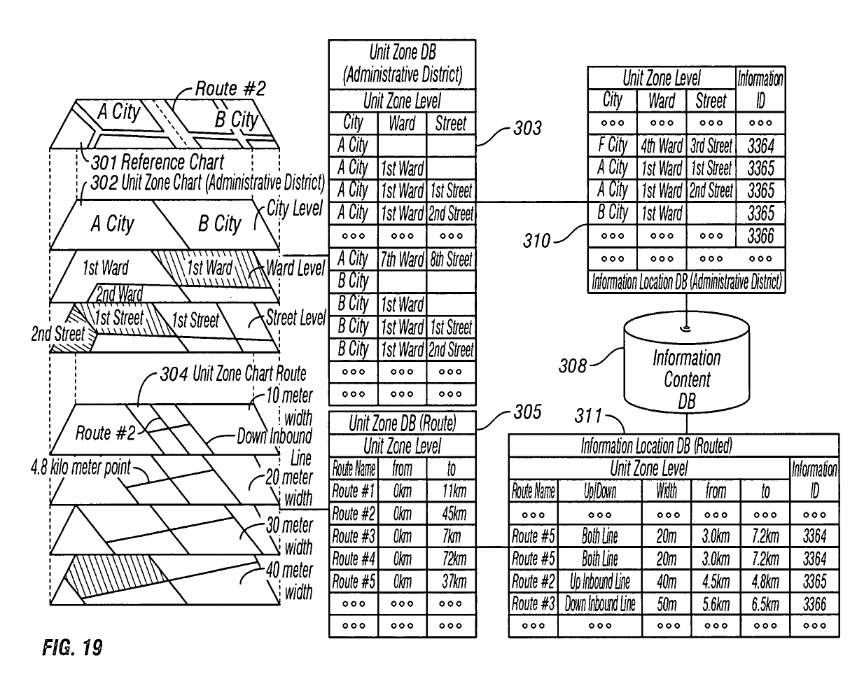

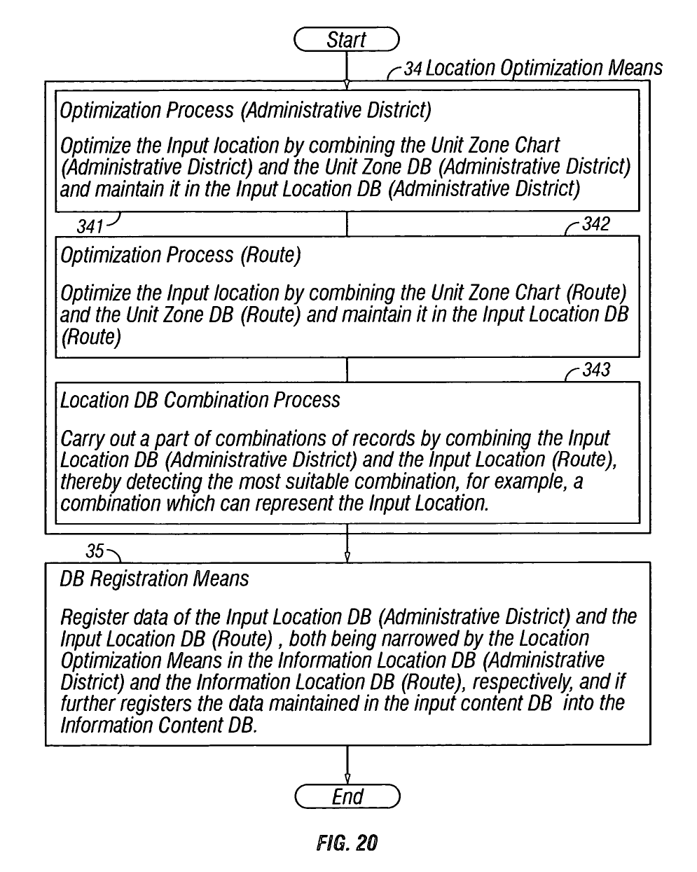

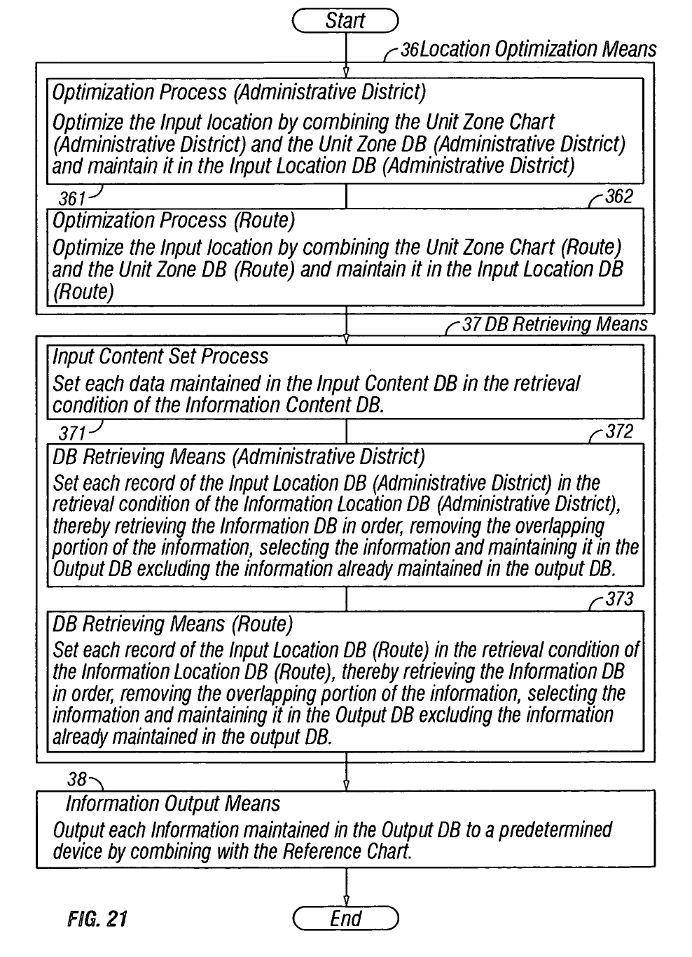

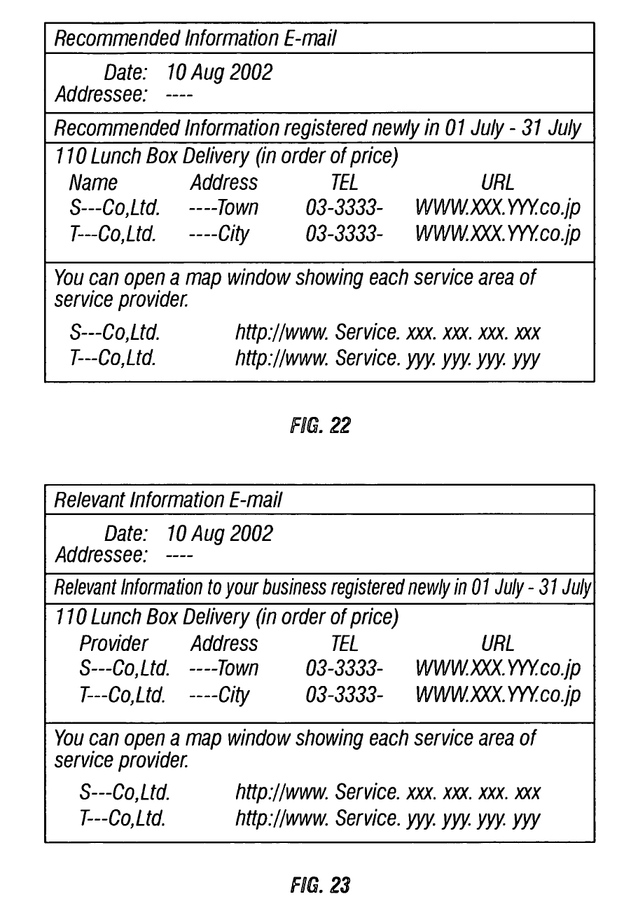

A third embodiment according to the present invention is described below: FIG. 18 is a block diagram illustrating a configuration of an information management system and main parts of an information management device in Embodiment 3; FIG. 19 is an example of configurations of a reference chart, a unit zone chart, a unit zone DB and an information DB in Embodiment 3; FIG. 20 is a process flow chart illustrating a location optimization process and DB registration means in Embodiment 3; FIG. 21 is a process flow chart illustrating location optimization means, DB retrieving means and information output means in Embodiment 3; FIG. 22 is an example of an output of recommendation information being outputted t a predetermined device by the information output means in Embodiment 3; and FIG. 23 is an example of relevant information being outputted to a predetermined device in Embodiment 3.

In FIG. 18, an information management device 30 is opened, being connected to a communication network 32 by a communication unit as not shown, and a terminal 31 of an information provider and a relay unit 33 are connected to the communication network 32 by the communication unit as not shown.

The information management device 30 enables for the information provider to register the information and enables for the information recipient to register the request. An information DB 307 is provided with an offer flag field and a request flag field, where “offer flag=1” or “request flag=0” is inputted in the information as registered; “offer flag=0” or “request flag=1” is inputted in the request as registered; and “offer flag=1” or “request flag=1” is inputted in the registered request as opened.

In the information management device 30, a timber 321 checks time; then DB retrieving means 32 selects information as registered in the information DB by combining, for example, the information and the request; information output means 323 outputs the information to the terminal 31 or a relay DB 331 of the relay unit 33 by referring to a reference DB 306. In the terminal 31, it is possible to register location information of the relay unit 33 as desired in advance though it cannot be said as operating all the time. The relay unit 33 is, for example, a mail server or a disk server of lending a part of the memory.

In FIG. 19, a reference chart 301; a unit zone chart (administrative district) 302 dividing a space by administrative district and a unit zone DB (administrative district) 303; an information location DB (administrative district) 310 in which the information location is registered based on the unit zone DB (administrative district) 303; an unit zone chart (route) 304 dividing a space by route extension and a unit zone DB (route) 305; an information location DB (route) 311 in which the information location is registered based on the unit zone DB (route) 305; and an information content DB 308 in which the information content is registered are related one another.

For example, the information location of “information ID=3365” is indicated by three unit zones being partially emphasized and marked with slant lines in the unit zone chart (administrative district) 302, and three records are registered in the information location (administrative district) 310; and it is indicated by one unit zone being partially emphasized and marked with slant lines in the unit zone chart (route) 304, and one record is registered in the information location DB (route) 311. The three records registered in the information location DB (administrative district) 310 and the one record registered in the information location DB (route) 311 are spatially and partly overlapping but the corresponding overlap does not make a matter in either the DB registration means or the DB retrieving means.

FIG. 20 illustrates a series of processes by location optimization means 34 of optimizing the input location after information is inputted, and DB registration means 35 of registering the information in the information DB.

The location optimization means 34 optimizes the input location by combining the unit zone chart (administrative district) and the unit zone DB (administrative district) and maintains it in the input location DB (administrative district) [optimization process (administrative district) 341]; the location optimization means 34 separately optimizes the input location by combining the unit zone chart (route) and the unit zone DB (route) and maintains it in the input location DB (route) [optimization process (route) 342]; and the location optimization means 34 carries out a part of combinations of records by combining the input location DB (administrative district) and the input location DB (route), thereby detecting the most suitable combination, for example, a combination which can represent the input location by the minimum number of records.

The DB registration means registers layers of the input location DB (administrative district) and the input location DB (route), both being narrowed by the location optimization means in the information location DB (administrative district) and the information location DB (route), respectively, and it further registers the data maintained in the input content DB into the information content DB.

If the location optimization means 34 and the DB registration means 35 combine unit zones of two or more unit zone charts and unit zone DBs having no relation each other and register the input content and the input location in the information content DB and the information location DB, respectively, the process order is not defined as one shown in the figure.

FIG. 21 illustrates a series of processes in the location optimization means 36 optimizing the input location after the request is inputted; the DB retrieving means 32 retrieving the information DB; and the information output means 38 outputting the information to a predetermined device.

The location optimization means 36 optimizes the input location by combining the unit zone chart (administrative district) and the unit zone DB (administrative district) and maintains it in the input location DB (administrative district) [optimization process (administrative district) 361] and the location optimization means 36 separately optimizes the input location by the unit zone chart (route) and the unit zone DB (route) and maintains it in the input location DB (route) [optimization process (route) 362].

The DB retrieving means 37 sets each data maintained in the input content DB in the retrieval condition of the information content DB [input content set process 371] and each record of the input location DB (administrative district) in the retrieval condition of the information location DB (administrative district), thereby retrieving the information DB in order, removing the overlapping portion of the information, selecting the information and maintaining it in the output DB [DB retrieving process (administrative district)]; and the DB retrieving means 37 sets each record of the input location DB (route) in the retrieval condition of the information location DB (route) and retrieves the information DB, thereby removing the overlapping portion of the information, selecting the information and maintaining it in the output DB excluding the information already maintained in the output DB [DB retrieving process (route) 373].

The information output means 38 outputs each information content maintained in the output content DB of the output DB to a predetermined device by combining with the reference DB. If the information location is requested, each information location maintained in the output location DB is outputted to the predetermined device by combining with the unit zone chart and the unit zone DB and again the reference chart [information output means 38].

If the location optimization means 36, the DB retrieving means 37 and the information output means 38 combine the input location by less unit zones of two or more unit zone charts and unit zone DB having no relation each other as for the input location; and these means combine the input content and the input location with the information content DB and the information location DB and output the selected information to the predetermined device, the process order is not defined as one shown in the figure.

FIG. 22 is an example of an output of recommendation information, the recommendation information being selected by the request registered in the information DB by the information management device per regular period and being outputted to a predetermined device in an e-mail format. The predetermined device is, for example, a terminal or a relay unit like a mail server.

The figure illustrates an output of a URL mapping and representing an outputted date, an outputted recipient, term being an object for selection, a point of each selected information and an information location of each information. If a request is registered with respect to restaurant information including a desired request location, a corresponding recommendation information is related to the restaurants that open within the corresponding request location within a predetermined period. Even though the information recipient does not request the information by accessing to the information management device several times, he can receive updated information per regular period by registering the request once.

FIG. 23 is an example of an output of relevant information, the relevant information being outputted to a predetermined device in an e-mail format by selecting other information on the basis of each request registered in the information DB by the information management device per regular period. The predetermined device is, for example, a terminal or a relay unit like a mail server.

The figure illustrates an output of a URL mapping and representing an outputted date, an outputted recipient, term being an object for selection, a point of each selected information and an information location of each information. If a request is registered with respect to delivery pizza house including a desired information location, a corresponding relevant information is related to the registered trades in which at least a part of the information location is overlapped within a corresponding information location during a predetermined period. Even though the information recipient does not request the information by accessing to the information management device several times, he can receive updated information per regular period by registering the request once.

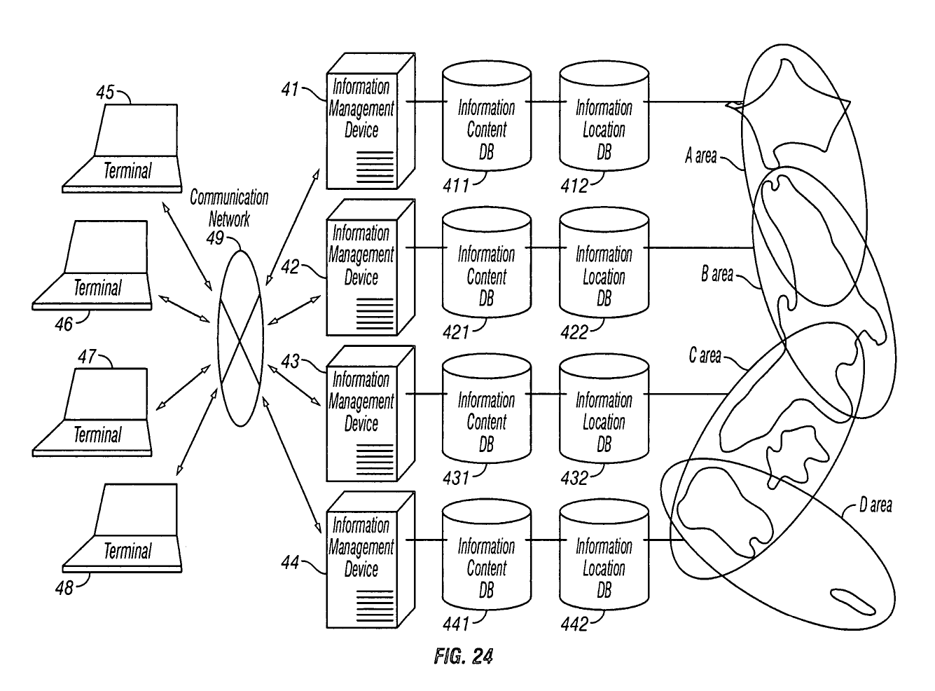

A fourth embodiment according to the present invention is described below: FIG. 24 is a configuration diagram of an information management system in Embodiment 4.

In FIG. 24, an information management device 41˜44 and a terminal 45˜48 are connected to a communication network 49. An information DB is divided by an information content DB 411˜441 and an information location DB 412˜442, each being connected to the information management device 41˜44 and enabling information of each of areas A, B, C and D to be registered. As the information has spatially a range, one information can be registered by overlapping in a plurality of the information DBs.

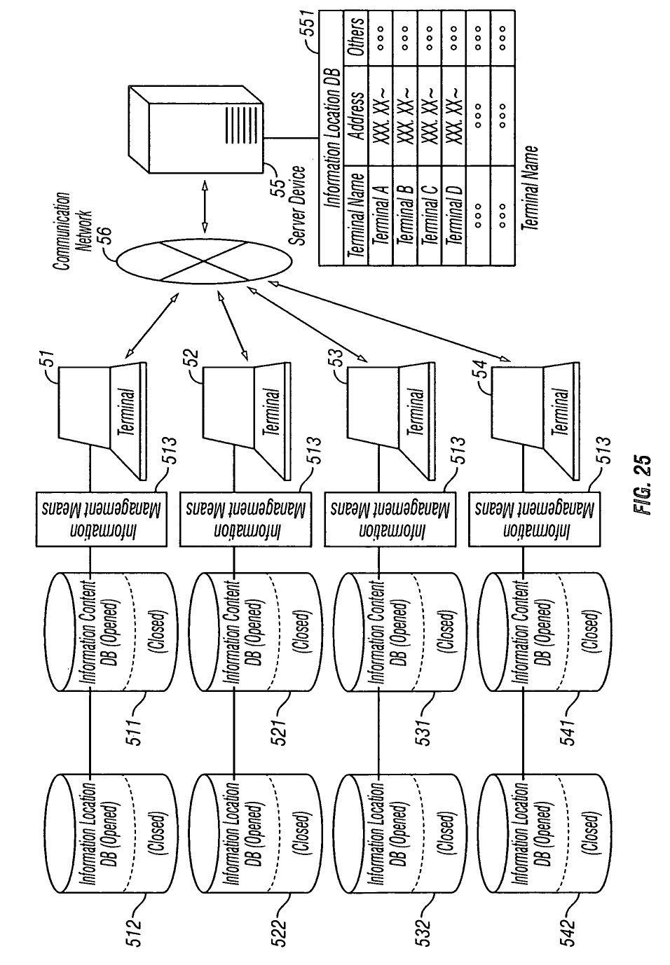

A fifth embodiment according to the present invention is described below: FIG. 25 is a configure diagram of an information management system in Embodiment 5.

In FIG. 25, a terminal 51˜54 and a server 55 are connected to a communication network 56. The terminal 51˜54 includes at least information management means 513˜543, an information content DB 511˜541 and an information location DB 512˜542 as main parts in the information management, respectively; and the communication network 56 enables non-opened information and opened information to be registered. The information opened in each terminal can be requested in the other terminals; therefore, the server 55 has each means for registering location information (for example, domain name) with respect to the communication network 56 of each terminal declaring to open and an information location D551 in which the location information is registered; and it is not required to have the information management main parts.

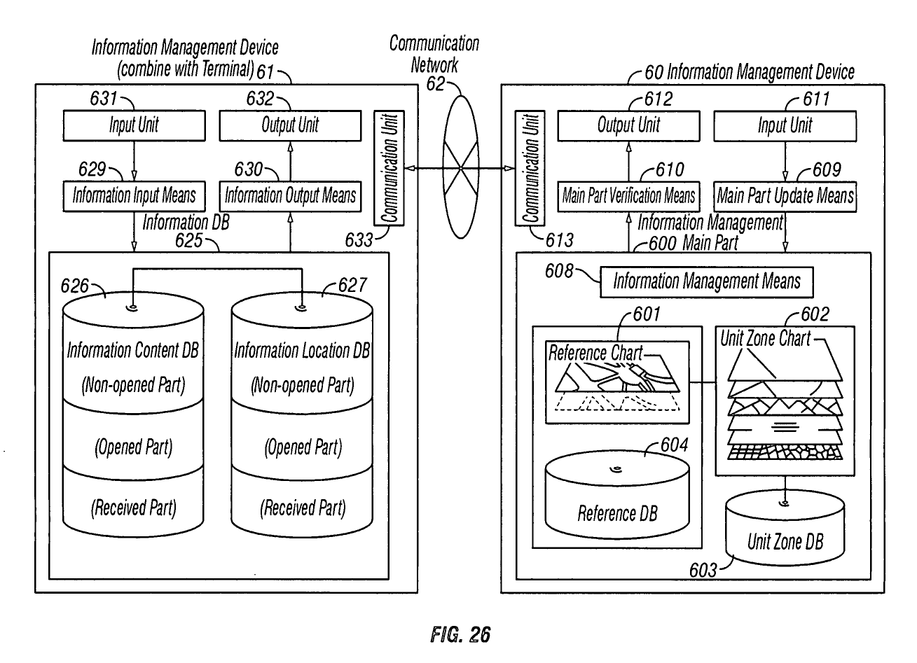

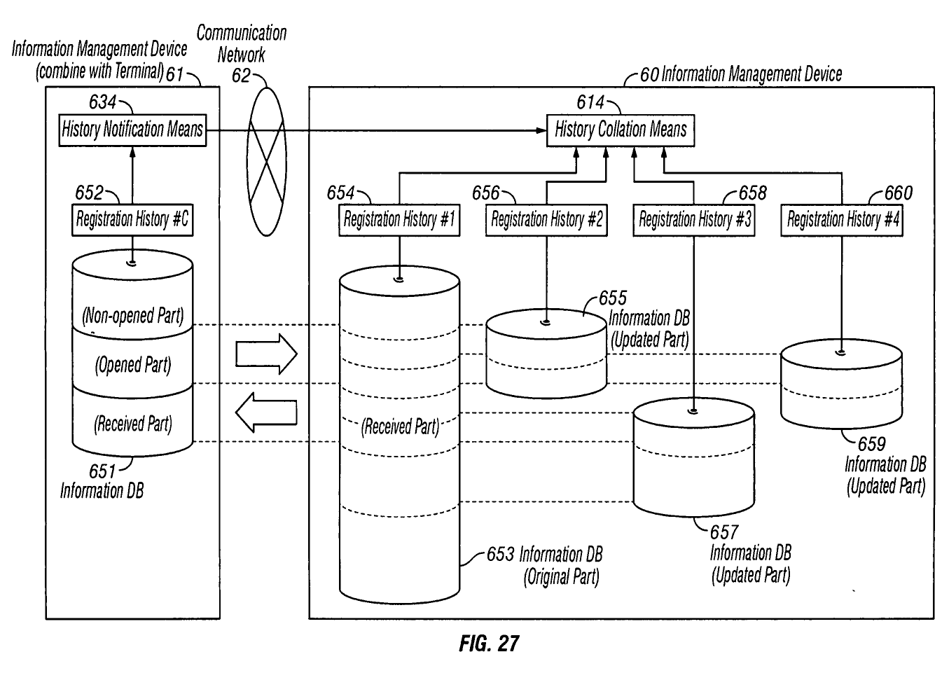

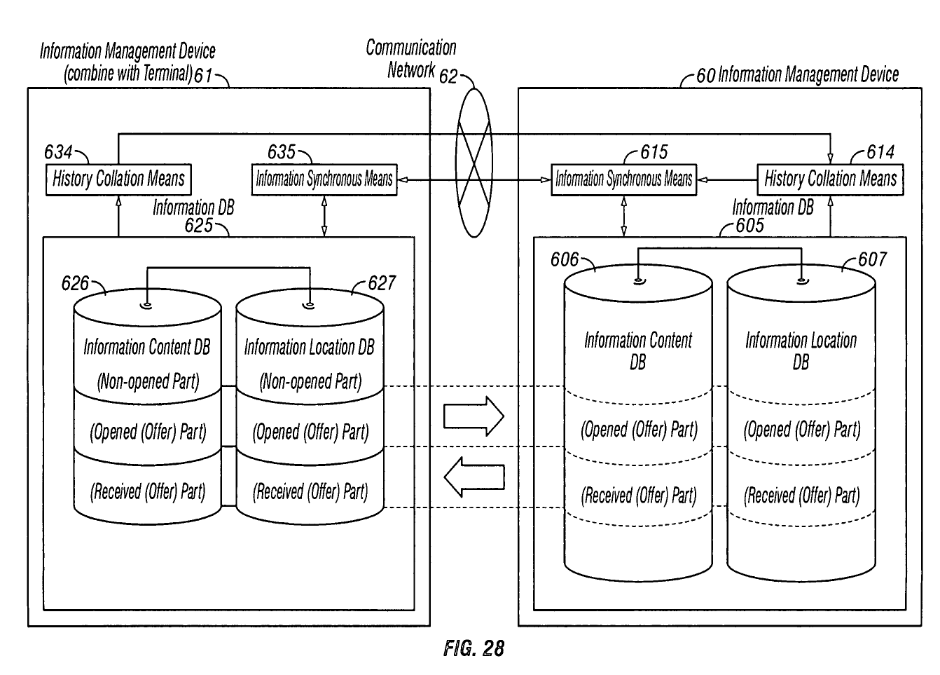

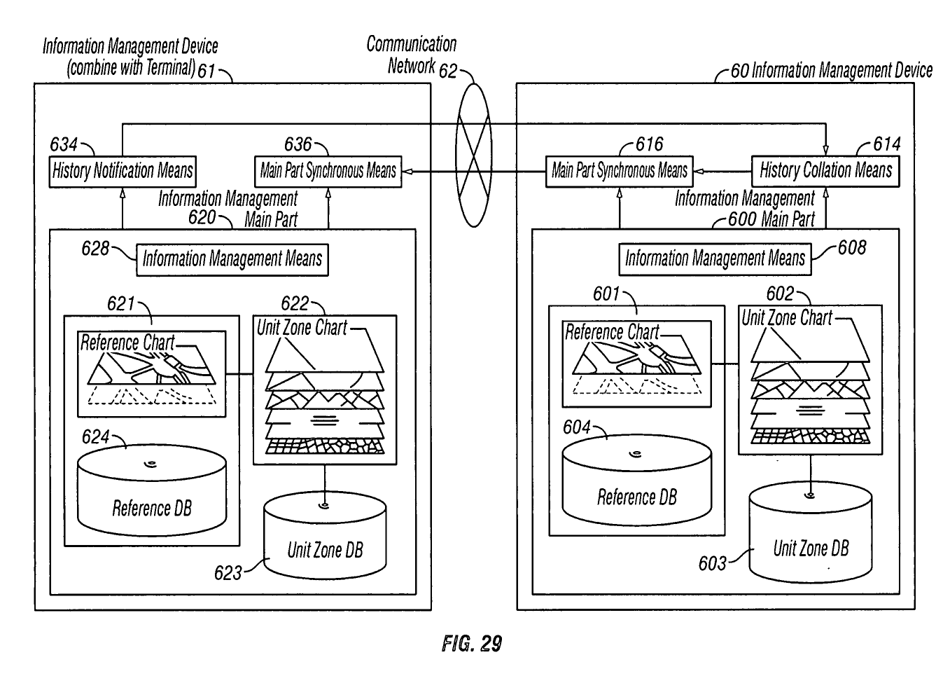

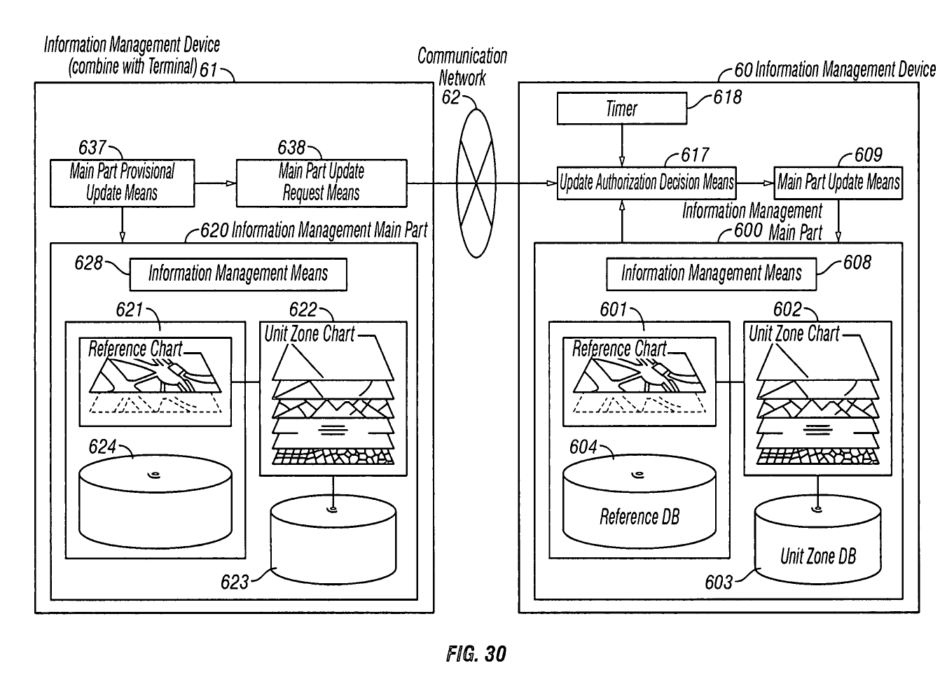

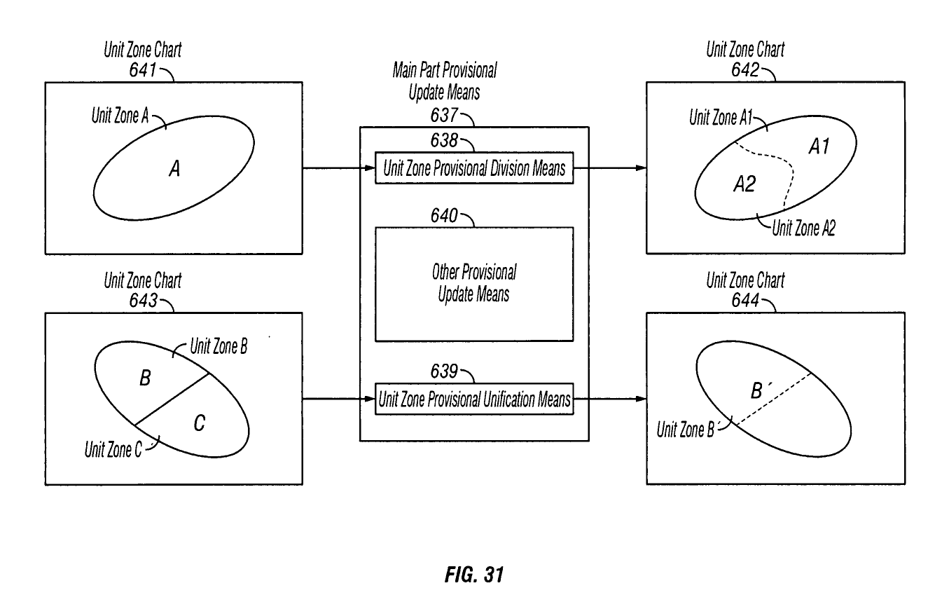

A sixth embodiment according to the present is described below: FIG. 26 is a block diagram illustrating a configuration of an information management system and main parts of an information management device in Embodiment 6; FIG. 27 is a block diagram illustrating history combination means for combining registration history of an information DB in Embodiment 6; FIG. 28 is a block diagram illustrating information synchronous means for synchronizing the information DB in Embodiment 6; FIG. 29 is a block diagram illustrating main part synchronous means for synchronizing information management main parts in Embodiment 6; FIG. 30 is a block diagram illustrating main part update means for updating the information management main parts having an information management device upon a request for update in other terminals in Embodiment 6; and FIG. 31 is a block diagram main part provisional update means for provisionally updating the information management main parts by other terminals in Embodiment 6.

In FIG. 26, in an information management system, an information management device 60 and another information management device 61 being a terminal are connected to a communication network 62. Although the information management device 60 and 61 are separately illustrated in the figure, two or more can be connected to the communication network 62.

The information management device 60 comprises at least information management main part 600, main part update means 609 of updating the information management main part 600, main part verification means 610 of verifying the information management main part 600, an input unit 611 such as a key board, an output unit 612 such as a display, and a communication unit such as a modem. The information management main part 600 names collectively information management means 608 which also names collectively each means to manage the information such as the DB registration means, each figure and each DB to manage the information excluding the information DB, specifically, it names collectively a reference chart 601, a unit zone chart 602, a unit zone DB 603 and a reference DB 604. The information management main part 600 can be jointly used by all users of the information management system and it should not be changed by some users. Therefore, the information management main part 600 can be updated by mangers of the information management system only.

The information management device 61 comprises at least an information DB 625, information input means 629 of inputting information in the information DB 625, information output means 630 of outputting the information in the information DB 625, an input unit 631 such as a key board, an output unit 532 such as a display and a communication unit 613 such as a modem. The information DB 625 registers a non-opened part, an offered part and an acknowledged part, the non-opened part being registered in the information management device 61 with respect to both information content DB 626 and information location DB 627 and being used as a stand-alone, the offered part being registered in the information management device 61 and providing a copy to the information management device 60, and the acknowledged part being outputted in the information management device 60. For example, the non-opened part is what a user does not want to open to the public like secrete information of a restaurant; the offered part is what a user wants to open like recommendation information of a restaurant; and the acknowledged part is another recommendation information of a restaurant which is outputted by the other information provider.

In FIG. 27, the information DB in the information management device 60 consists of an information DB 653 being pre-registered before operating the information management system, an information DB 655 being provided by the information management device 61, and n information DBs from information DB 657 to information DB 659 being provided by other apparatus, each information DB attaching registration history 1 (654), registration history 2 (656), registration history 3 (658) and registration history 4 (660). Except for the information DB being separately managed as shown in the figure, it is possible to unify it in one DB and to carry out by preparing relevant registration history. The information DB 651 registers a non-opened part being registered in the information management device 61 and being used as as stand aron, an offered part being registered in the information management device 61 and offering a copy to the information management device 60, and an acknowledged part being outputted in the information management device 60.

History notice means 634 reads registration history 652 of the information DB 651, notifies it to the information management device 60 and requests synchronous (update) of the information DB 651; and history combination means 614 read registration history 1˜n (654˜660) and combines them with the registration history 652.

Although the figure shows a block diagram of the means combining the registration history of the information DB, it is possible to combine the registration history by attaching the registration history to each means and DB of the information management main part, the means is not shown in the figure because it is the same as the information DB.

In FIG. 28, the history notice means 634 notifies the registration history of the information DB 625; the history combination means 614 combines with each registration history of the information DB 653˜659; if there are any differences in the registration history, the information synchronous means 615 outputs an updated part among the information as requested in the information management device 61 of the information DB 605 and an acknowledged part in the figure to the information management device 61; and the information synchronous means 635 updates the information DB 625.

In FIG. 29, the history notice means 634 notifies the registration history of the information management main part 620; the history combination means 614 combines the history with each registration history of the information management main part 600; if there are any differences in the registration history, the main part synchronous means 616 outputs an updated part of the main part as requested in the information management 61 of the information management main part 600 to the information management device 61; the main part synchronous means 636 updates the information management main part 620. The information management main part 620 names collectively the information management means 628 calling each means to manage the information of the DB registration means and each figure and each DB to manage the information except for the information DB, specifically, a reference chart 621, a unit zone chart 622, a unit zone DB 623 and a reference DB 624.

At least a part of the information management main part can be updated by others than managers of the information management device 60. For example, since roads can be newly made, it is effective to provide updated information by ordinary information providers in the reference chart and the unit zone chart.

Accordingly, in FIG. 30, main part provisional update means 637 provisionally updates at least a part of the information management main part 620; main part update request means 638 notifies provisionally updated information and requests to update the main part; a timer 618 checks time; update authorization decision means 617 decides whether or not update authorization; if authorized, main part update means 609 updates the information management main part 600. Each means shown in FIG. 28 can updates the information management main part 620 being provisionally updated in the information management device 61.

In FIG. 31, the main part provisional update means 637 comprises unit zone provisional division means 638 provisionally dividing the unit zone, unit zone provisional unification means 639 provisionally unifying the unit zone, and other provisional update means 640 provisionally updating the other main part.

The unit zone provisional division means 638 provisionally divides the unit zone A of the unit zone chart 641 into the unit zone A1 and unit zone A2 in the unit zone chart 642 being a provision figure and registers the same; the unit zone provisional unification means 639 provisionally unifies the unit zones B and C of the unit zone chart 643 as the unit zone B′ in the unit zone chart 644 being the provisional figure and registers the same. The provisional figure is used for the purpose of provisional registration of information, and therefore, the information management device 61 is provided with an information provisional DB to provisionally register the information; the information DB is associated with the unit zone chart 641 (643) and the information provisional DB is associated with the unit zone chart 642 (644)

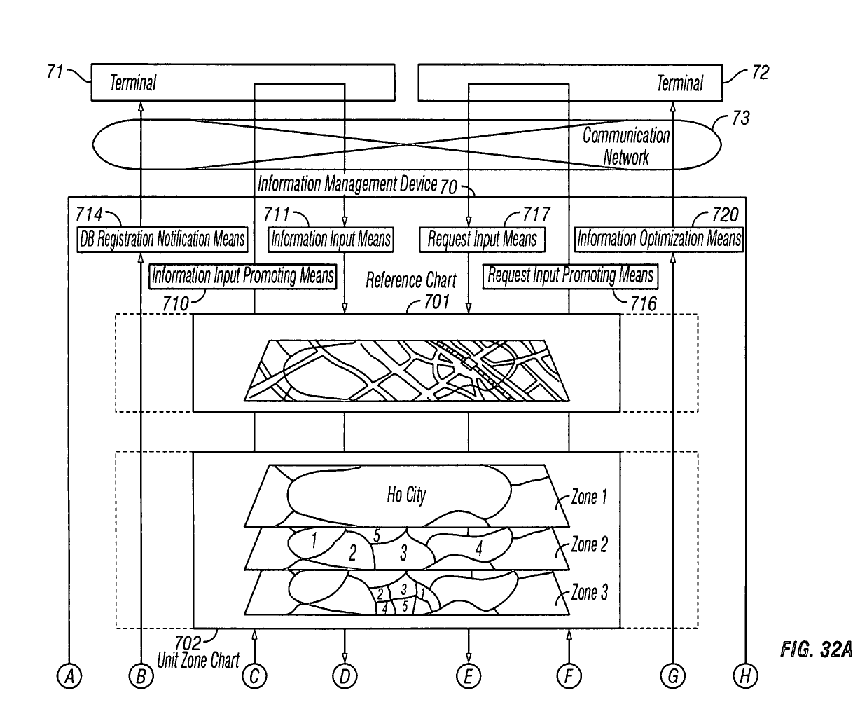

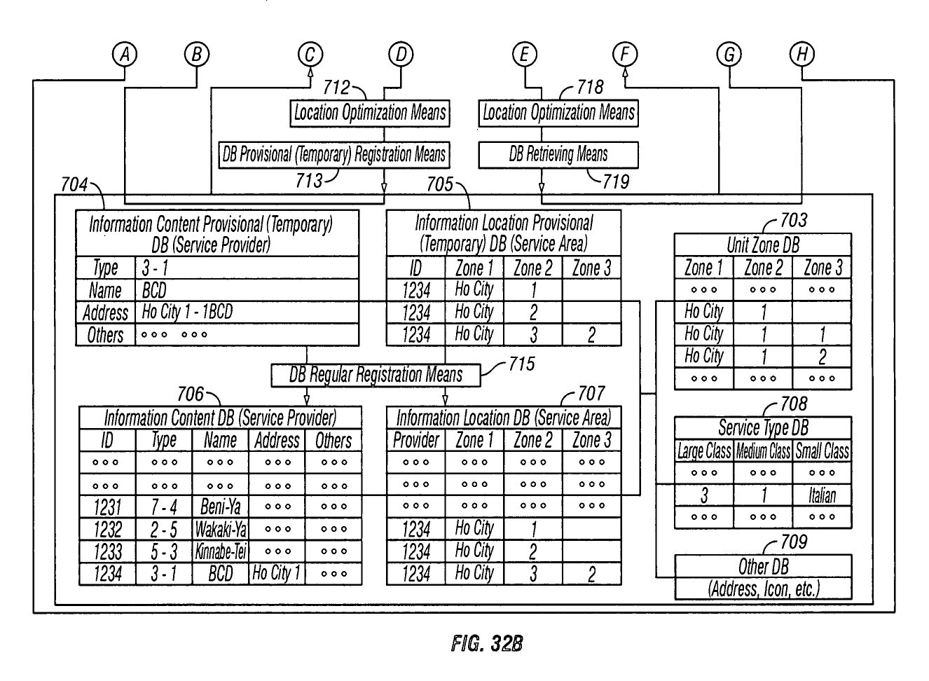

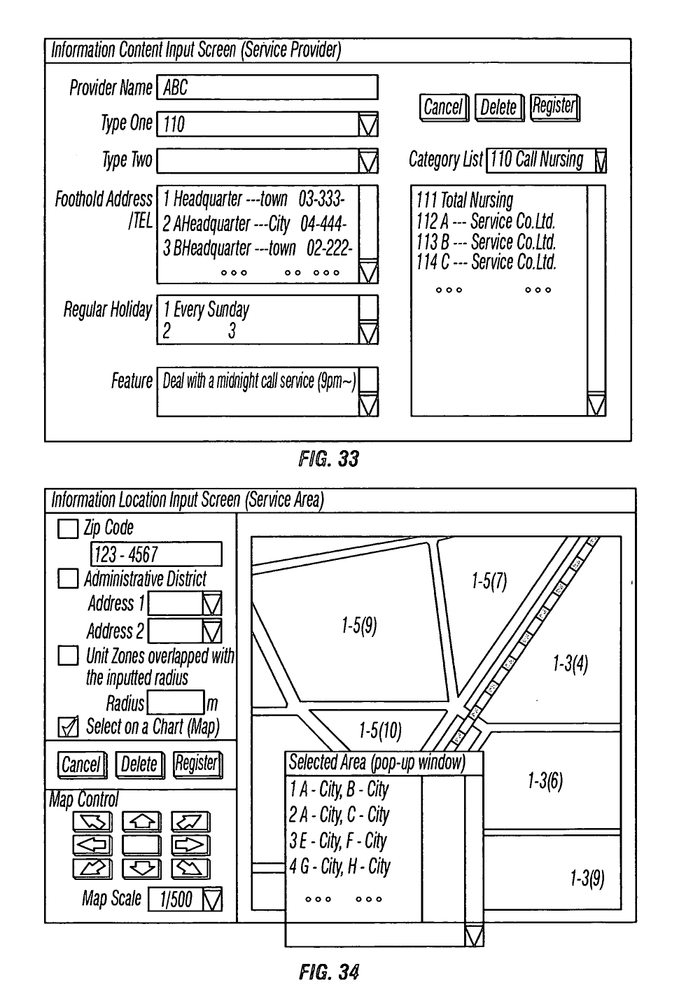

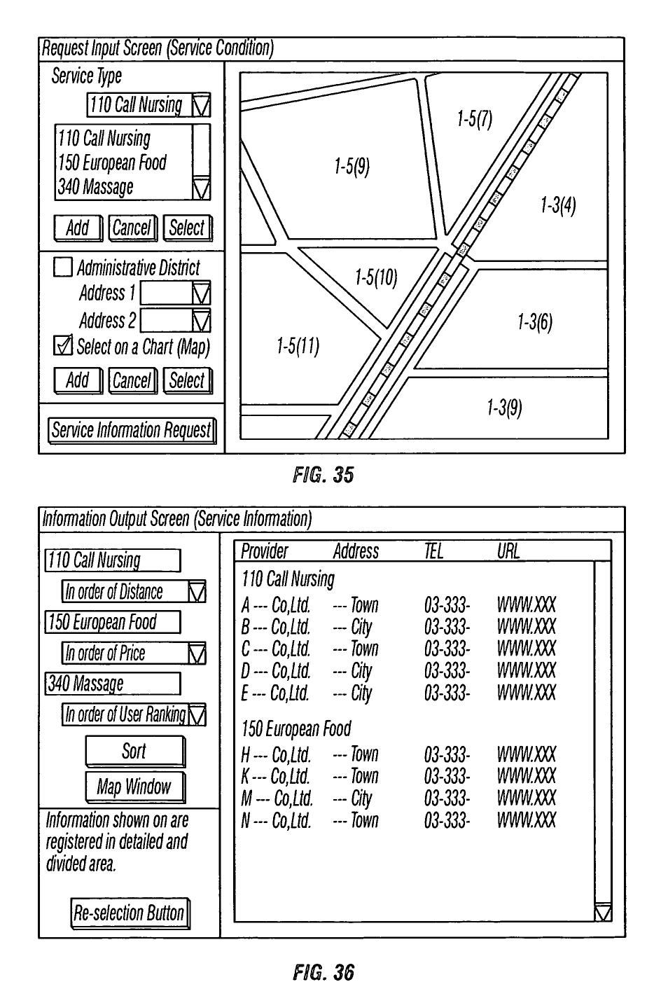

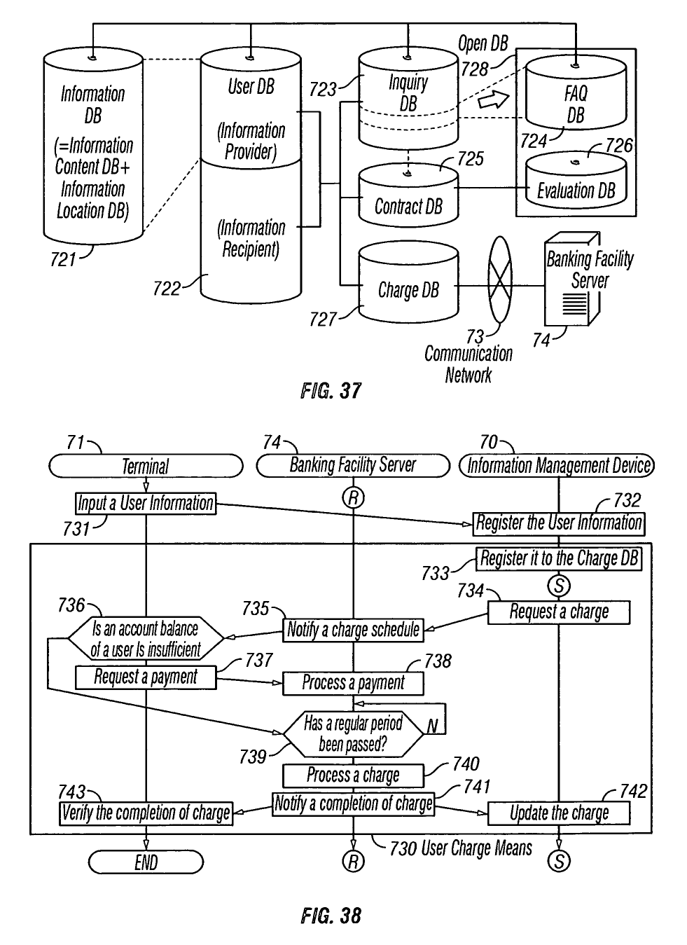

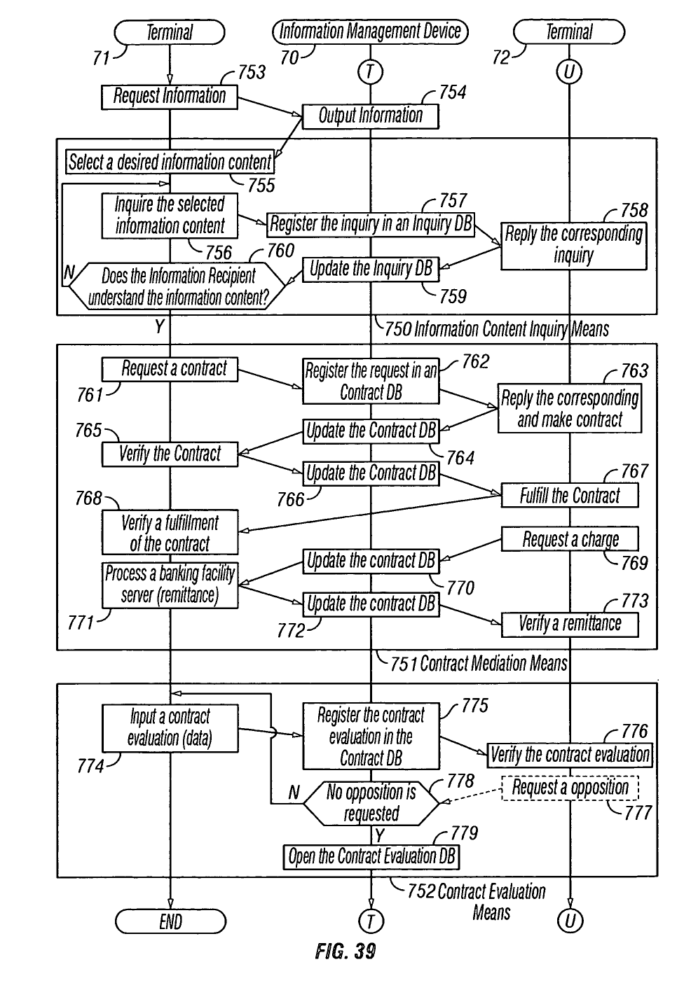

A seventh embodiment according to the present invention is described below: FIG. 32 is a configuration diagram of an information management system and a block diagram of main part of an information management device in Embodiment 7; FIG. 33 is an example of an output of an information content input screen to be outputted to a predetermined device by information input prompt means in Embodiment 7; FIG. 34 is an example of an output of an information location input screen to be outputted to a predetermined device by information input prompt means in Embodiment 7; FIG. 35 is an example of an output of a request input screen to be outputted to a predetermined device by request input prompt means in Embodiment 7; FIG. 36 is an example of an output of an information output screen to be outputted to a predetermined device by information output means in Embodiment 7; and FIG. 37 is an example of a configuration of an information DB, a user DB, an inquiry DB, a contract DB, a charge DB and an open DB in Embodiment 7; and FIG. 38 is a process flow chart illustrating user charge means in Embodiment 7; and FIG. 39 is a process flow chart illustrating information content inquiry means, contract mediation means and contract evaluation means in Embodiment 7.

In FIG. 32, an information management device 70 is opened being connected to a communication network 73 by a communication unit not shown in the figure; a terminal 71 of an information provider and a terminal 72 of an information recipient are connected to the communication network 73 by the communication unit not shown to access to the information management device 70. The information management device 70 comprises a reference chart 701 to be referred to by the information provider and the information recipient, a unit zone chart 702 and a unit zone DB 703 in which a space is divided in a plurality of unit zones, a reference DB including a service type DB 708 and the other DB 709, an information provisional DB including an information content provisional DB 704 to provisionally register the information content and an information location provisional DB 705 to provisionally register the information location of the inputted information, and an information DB including an information content DB 706 to regularly register the information content and an information location DB 707 to regularly register the information location.

Although the unit zone chart 702 basically classifies zone 1 by cities, zone 2 by streets and zone 3 by residence numbers, since at least a part of unit zones is divided by factors which affect traffic such as rail roads and roads, if it is divided as three zones having different traffic conditions, the corresponding three zones are prepared as different unit zones. For example, if one least administrative district is divided into four zones where the traffic conditions are different from one another, the corresponding four zones are prepared as unit zones, respectively.

The service type DB 708 in the reference DB classifies services by types and registers the same, and the other DB prepares, for example, an icon DB to register an icon to illustrate each facility on the reference chart 701.

In the information management device 70, if a request is made from the terminal 71, the information input prompt means 710 outputs the information input screen to the terminal 71 and prompts the information input. The information input screen displays at least a part of the reference chart 701 to easily input the information location.

If information is inputted, information input means 711 maintains the information in the memory for some time; if an information location is inputted, location optimization means 712 optimizes the information location, DB provisional registration means 713 provisionally registers the information content in the information content provisional DB and the information location in the information location provisional DB, respectively. DB registration authorization provisional decision means not shown in the figure authorizes the provisionally registered information according to a predetermined rule, and DB regular registration means 715 regularly registers the information by transferring it to each of the information content DB 706 and the information location DB 707.

If the regular registration is completed, DB registration notice means 714 notifies the provisional registration to the terminal 71 and decides unique identification information and notifies the same. Then, the information provider can update the information which was registered by inputting the corresponding identification information.

In the information management device 70, if a request is made in the terminal 72, request input prompt means 716 prompts a request input by outputting a request input screen to the terminal 72. The request input screen can display at least a part of a reference chart 701 to easily input a request location.

If a request is inputted, request input means 717 maintains the request in a memory for some time; and if a request location is inputted, location optimization means 718 optimizing the request location, DB retrieving means 719 selects information by combining the request with the information DB, and information output means 720 outputs information to the terminal 72.

In FIG. 33, an information content input screen enables information content to be inputted. In this embodiment, the information content is the information's other names, positions, features and types. A screen right window displays so that classification 2 re-divided from classification 1 as selected can be selected. If a registration button is selected after the information content is inputted, an information location input screen is displayed.

In FIG. 34, an information location screen is provided four means enabling the information location to be inputted. In the upper, there are a zip code selection, an administrative district selection, a radius designation selection and a selection on a map. In another embodiment, it is possible to select a city call range by inputting a telephone number. The information location is inputted by selecting an addition and/or deletion button and using each of the means mentioned above. In the radius designation selection, it is possible to changeably select a unit zone being entirely included in a circle designating a center and radius and a unit zone being partly extended over a circle.

A selection end range (popup) window displays a table to verify the inputted information location in total till then. A zone selecting a whole territory is represented as record 1, and a zone selecting a part as a re-divided unit is represented one or two or more records.

In FIG. 35, a request input screen enables a request content and a request location to be inputted. Simultaneously, it enables the request content such as two or more service types to be inputted. The request location which the service is desired is inputted by the same method with that of the information location input screen

In FIG. 36, if two or more information is outputted by selecting a comparison/exchange button, an information output screen enables such a redisplay that corresponding information is newly displayed by a desired order, or it enables an information location of the information designated to an information recipient to be mapped and displayed by selecting a map display button.

In the figure, the mark “a selected range ˜” is displayed in the unit zone having two or more request location, and therefore it indicates that other information is registered within a corresponding request location. By selecting a map display button, the request location can be represented by being classified according to the ranges in which the other information is registered; by selecting a re-selection button, the request location is more narrowed. For example, if a request location is requested by selection units such as city, town and sub-county, an information output screen displays “a selected range ˜”; and if the request location is requested by a narrower unit such as street, the information can be also restricted.

In FIG. 37, the information management device 70 comprises a user DB 722 in which a user information is registered as each DB of which data size is increased or decreased in response to the information as registered except an information DB 71, an inquiry DB 723 in which inquiry history exchanged among users is registered, a FAQ DB724 in which information profitable to other users is selected in the inquiry DB 723 and the same is registered, a contract DB 725 in which information regarding contract exchanged among users is registered, an evaluation DB 726 in which evaluation of the contract is registered, and a charge DB 727 in which information regarding charge to a user is registered. The FAQ DB 724 and the evaluation DB 726 are opened by including an open DB 728 to be referred to in other terminals. The charge DB 727 is connected to the communication network 73 and is cooperated with a banking facility server 74.

In FIG. 38, if a user information is inputted in a terminal 71 of an information recipient (731), a corresponding user information is registered in an information management device 70 (732), user charge means 730 is performed by cooperating with the information management device 70, the terminal 71 of the information recipient and the banking facility server 74. Although this embodiment illustrates an embodiment of registering the information of the information recipient, other embodiments enables information from at least any one of the information recipient and information provider to be registered.

In user charge means 730, a charge information of a user in an information management device 70 is registered in a charge DB 727 (733); a charge is requested in a banking facility server 74 based on the charge information (734); a charge schedule is notified to a terminal 71 (or user) (735); if an account balance of a user is insufficient (736), payment is requested in the banking facility server 74 (737); the banking facility server 74 processes payment (738); after a regular period such as the end of the month has been passed (739), a charge process is performed (740); a completion of charge is notified to the information management device 70 and the terminal 71 (or user) (741); the charge DB 727 is updated in the information management device 70; and the completion of charge is verified in the terminal 71 (or user).

In FIG. 39, if information is requested in a terminal 71 of an information recipient (753), the information is selected and outputted in an information management device 70 (754); and as cooperation of an information management device 70 and a terminal 71 of an information recipient and a terminal 72 of an information provider cooperate with one another, information content inquiry means 750, contract mediation means 751 and contract evaluation means 752 are performed.

Information content inquiry means 750 selects a desired information content from outputted information in a terminal 71 (755); for example, an information content is inquired in an information management device 70 by selecting a desired delivery pizza house (756); a corresponding inquiry in the information management device 70 is registered in an inquiry DB 723 (757); and it is notified in a terminal 72 and the corresponding inquiry is replied in the terminal 72 (758); an inquiry DB 723 is updated in the information management device 70; and each of the processes above may be repeated (756) until the information recipient understands the information content (760).

In contract mediation means 751, a contract is request in a terminal 71 (761); a request for a corresponding contract in an information management device 70 is registered in a contract DB 725 (762); it is notified to a terminal 72 and the request of the corresponding contract is replied in the terminal 72 (763); a contract DB 725 is updated in the information management device 70 (764); the contract is verified in the terminal (765); the contract DB 725 is updated in the information management device 70 (766); the contract is fulfilled by an information provider (767); a fulfillment of the contract is verified by an information recipient (768); a charge is requested by the information provider (769); the contract DB 725 is updated in the information management device 70 (770); a payment through a banking facility server is processed by the information recipient (771); the contract DB 725 is updated in the information management device 70 (772); and a remittance is verified in the terminal 72 (773).

In contract evaluation means 752, a contract evaluation such as the standard of satisfaction with a contract is inputted by an information recipient (774); a corresponding contract evaluation in an information management device 70 is registered an evaluation DB 726 (775); the contract evaluation is verified by an information provider (776); any opposition is requested if any (777); if the opposition is requested in the information management device 70 (778); a corresponding opposition is notified in an information terminal 71; and each of the processes above is repeated until any agreement between the information recipient and the information provider, then an evaluation DB 726 is opened in the information management device 70 (779).

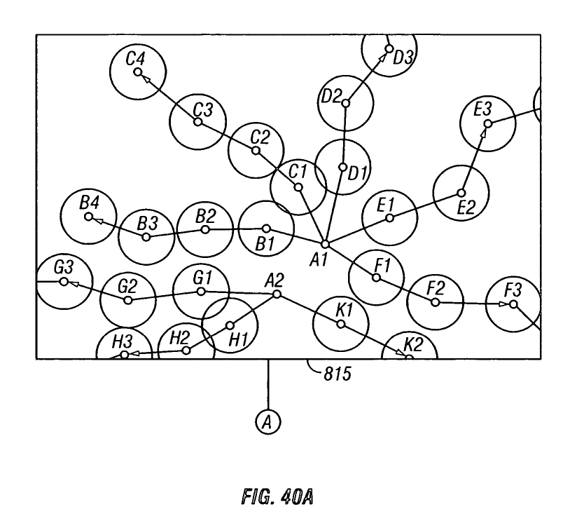

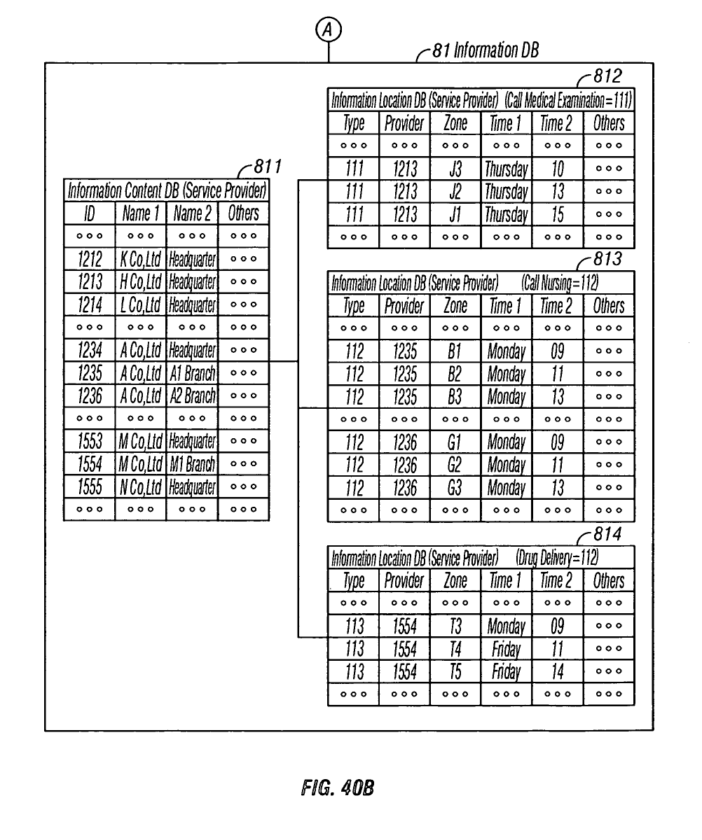

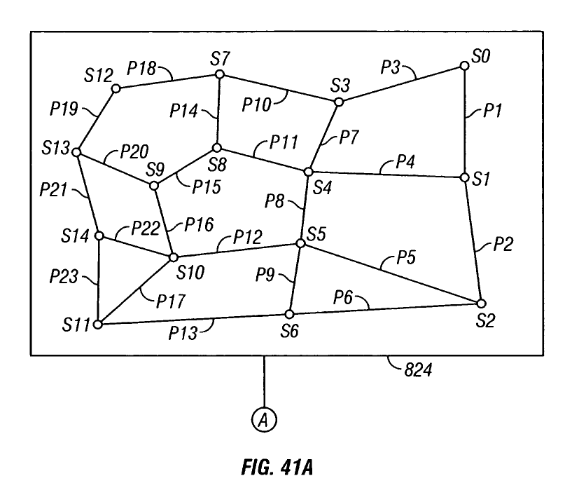

An eighth embodiment according to the present invention is described below: FIG. 40 is an example of an output of a map which displays main part of an information DB and a registered spatial location in Embodiment 8.

In FIG. 40, an information DB 81 comprises an information location DB divided by service types (812˜814) and an information content DB 811 related by an information provider ID field.

A map indication 815 displaying a service range indicates an example of an information location registered in an information location DB, and A1, A2 are shown, for example, as a point A1 and a point A2 in a strongpoint of an service provider, B1˜4 are shown as their own touring route on Monday at a point A1, and G1˜4 are shown as their own touring route at a point 2. For example, a service range possible at each point of B1˜4 is illustrated in a circle shape for convenience, however, it basically becomes a polygon selecting one or two or more unit zones. The service range shown in the figure is, for example, a range of a city phone charge by a telephone company.

In the embodiment, a map indication 815 indicating a service range is a figure to represent a circuit network such as a phone circuit, A1, A2 are relay switches of a telephone company, K1˜K2 in B1˜B4 are base stations of a mobile phone company, a range indicated as a circle is a receivable range of each base station. An information management device is provided a road network chart and a railroad network chart in addition to a circuit network; each route registers required time according to the means of walk, car or train in an attribute DB in advance every line zone between relay points such as intersection or station; a range making It possible to visit to shop within a desired time is selected by receiving a request from a manager of the shop registered in a random location within a district to be objected, thereby making it possible to provide various information and/or special telegram using a mobile phone complemented by a terminal of a registered or each base station within a corresponding range.

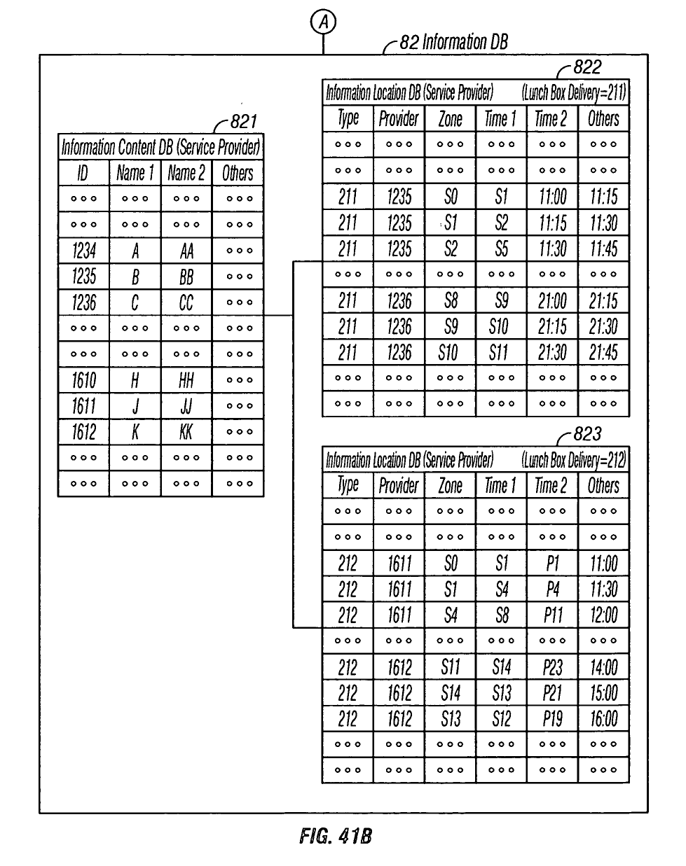

A ninth embodiment according to the present invention is described below: FIG. 41 is an example of an outputted map which indicates main part of an information DB and a registered spatial location in Embodiment 9.

In FIG. 41, an information DB 82 comprises an information location DB divided by service types (822˜823) and an information content DB 821 as related by an information provider ID field.

A map indication 824 indicating a service range illustrates an example of an information location as registered in an information location DB; S0˜S14 are an intersection on a road network, a station on a railroad network, or a post office on a post network; and P1˜P21 are a partial territory on the road network and the railroad network or a delivery territory on the post network. Information having a spatial range, for example, cyclic service information can be registered in relation to S0˜S14 and/or P1˜P21. The information in this embodiment is as for a delivery lunch shop (ID=211) and a delivery pizza house (ID=212).

If a desired request location is inputted by an information recipient, either a part being adjacent to a corresponding location of P1˜P21 and/or S0˜S14 or a part being near the corresponding location is selected, information for a re-selected location is selected and outputted to the information recipient.

An information location included in registered information in this embodiment enables a desired territory by a line zone to be selected and registered; a request location enables an area to be inputted; and the information location and the request location can become different data formats each other. Therefore, if a desired area is inputted in the request location by the information recipient, all route territories included in a corresponding area are inputted in an input location DB by combining the corresponding area with a route network chart in an information management device, and information is selected by combining the input location DB with the information location DB.

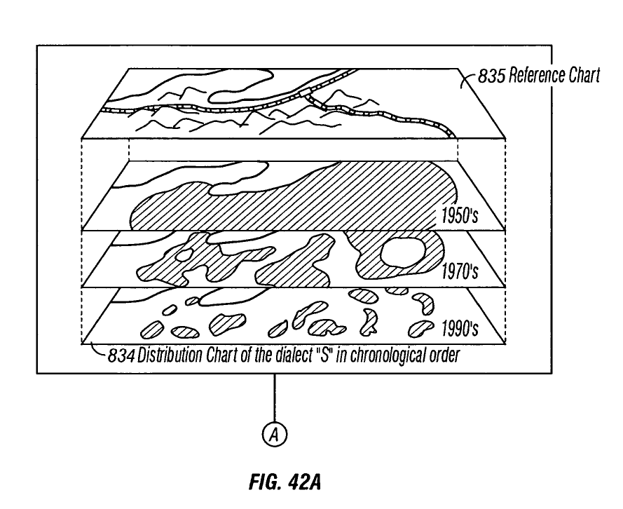

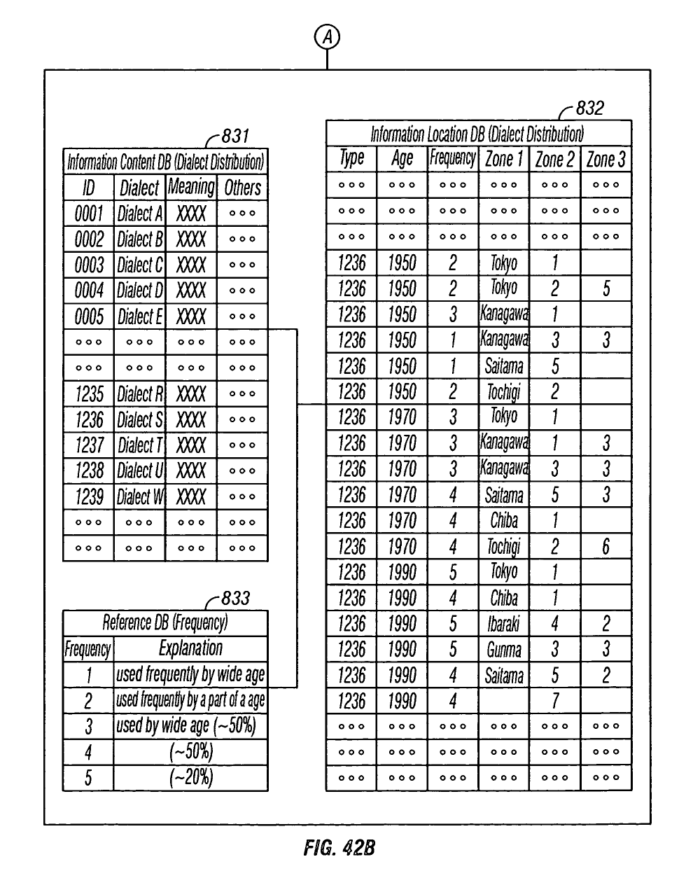

A tenth embodiment according to the present invention is described below: FIG. 42 is an example of an outputted map which indicates main parts of an information DB and a registered spatial location in Embodiment 10.

In FIG. 42, an information DB comprises an information content DB 831 in which a content of a dialect is registered and an information location DB 832 in which a distribution of each dialect is chronologically registered; and a reference DB 833 in which frequency of use of a dialect is classified is associated with the information DB. Information of the dialect can be widely provided by ordinary information providers.

A map indication 834 indicating a chronological distribution of a dialect S illustrates an example of an information location registered in an information location DB 832 and outputs a distribution chart of the dialect S in chronological order. A reference DB 835 is outputted overlapping the distribution chart.

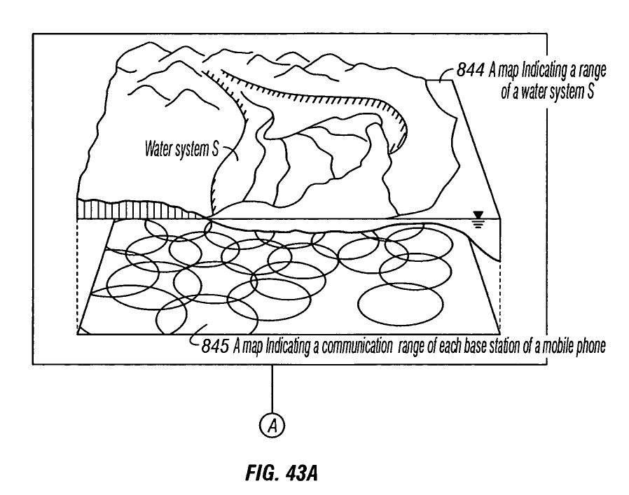

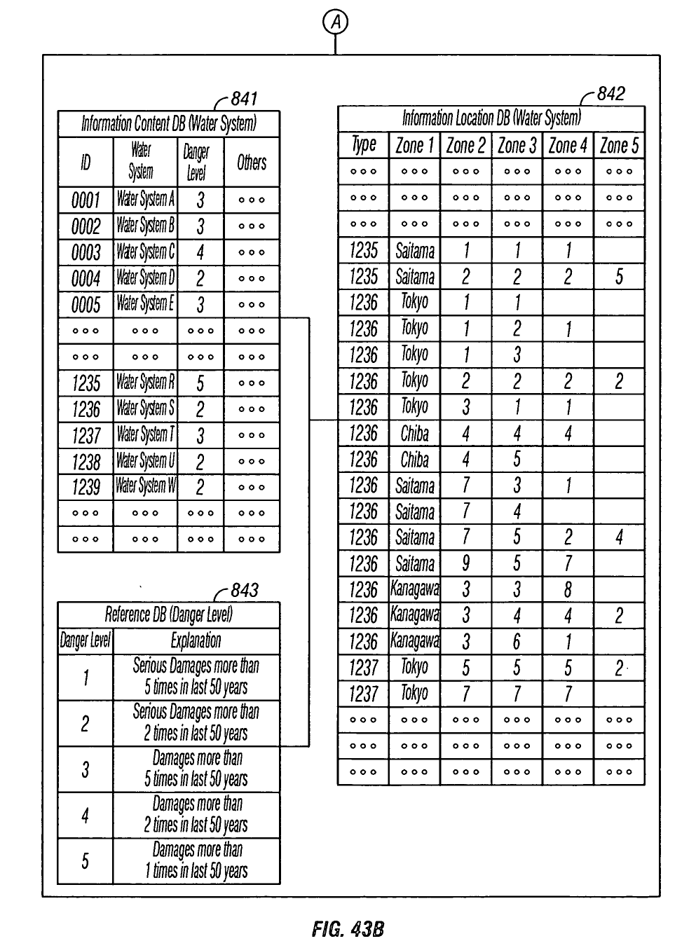

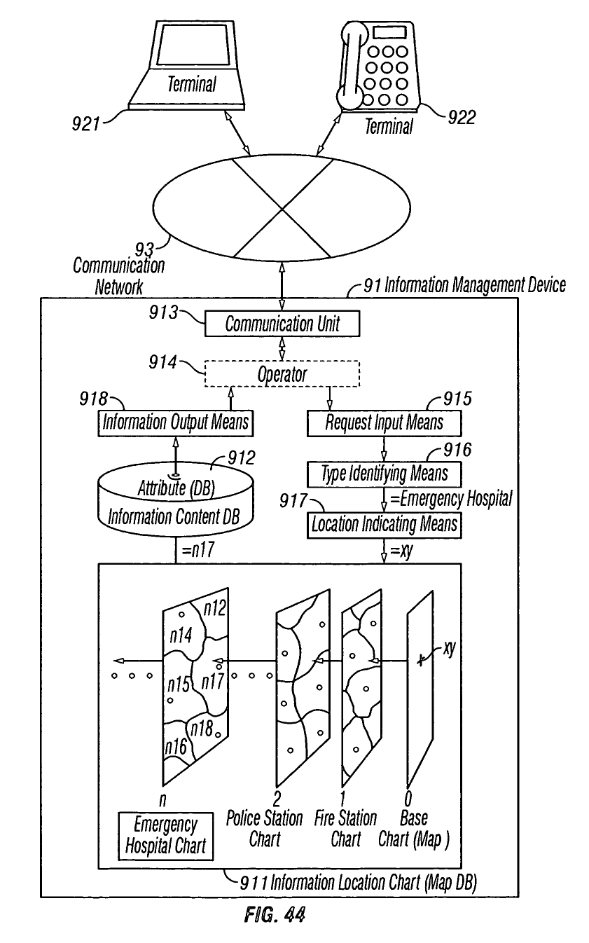

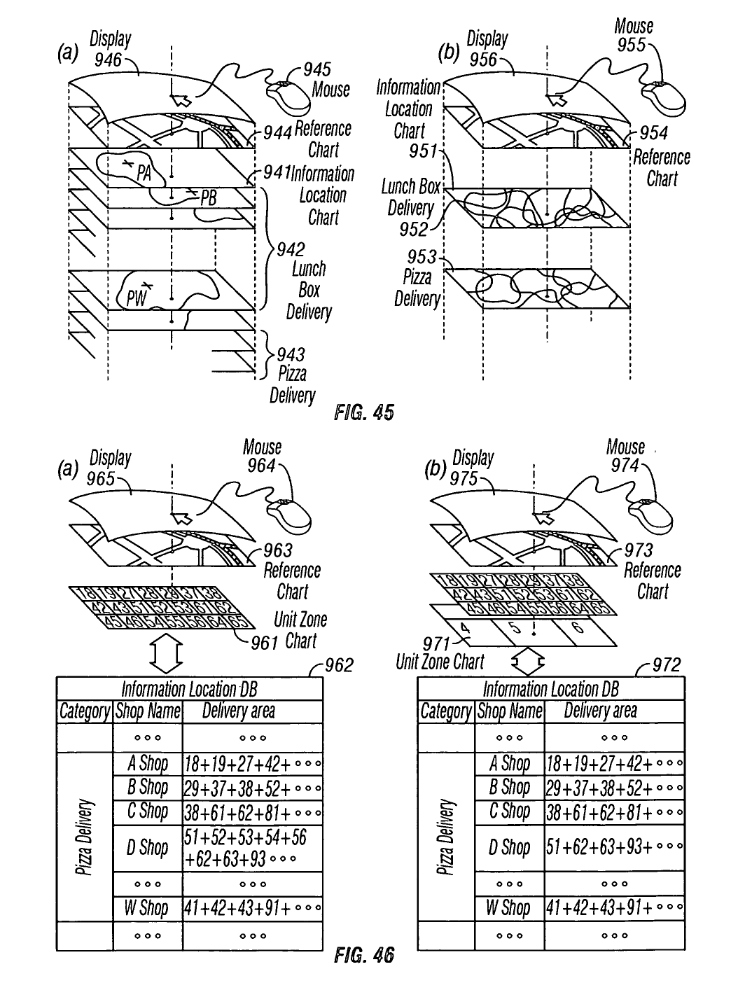

An eleventh embodiment according to the present invention is described below: FIG. 43 is an example of an outputted map which indicates main parts of an information DB and a registered spatial location in Embodiment 11.

In FIG. 43, an information DB comprises an information content DB 841 in which a content of a water system is registered and an information location DB 842 in which a range of each water system is registered, and a reference DB 843 which classifies a danger chart of the water system is associated with the information DB. The information of the water system can be provided by a manager of the water system.

A map indication 844 indicating a range of a water system S illustrates an example of an information location registered in an information location DB 842; A map indication 845 indicating a complementary range of each base station of a mobile phone based on an information registered in another DB illustrates an example of a complement range of each base station; if a water level of a river is over a limitation value, a danger is notified to a mobile phone expected to included in the water level of a corresponding river based on each figure.

Each of the embodiments described above provides an information management system in which information in relation to a spatial location is registered from a terminal to a DB connected to a host through a predetermined communication network and in which at least a part of the information is outputted to the terminal by requesting a spatial condition as the key, more particularly, an information management system in which at least any one of the spatial location and the spatial condition enables a spatially distorted area to be designated and a DB retrieving time is not almost affected by an amount of the information as registered, thereby being easily used.

Further, the information management system enables information of service business with a spatial range to be registered, it outputs the information and enables a plurality of service businessmen to compete one another with respect to the quality/quantity. The service business is, for example, a deliver service business, a visit service business or a communication service business.

### INDUSTRIAL APPLICABILITY

The present invention is used as an information management device in which information is registered in relation to a spatial location and the information is outputted with a spatial condition as a clue, more particularly, an information management system in which information is inputted and outputted by being connected to an information management device and an terminal through a predetermined communication network.

1. An information management system enabling information to be registered from a terminal to a database (DB) connected to a host computer through a communication network, comprising:
a space being pre-divided into a plurality of unit zones and re-divided into another plurality of unit zones;
information input means enabling an information provider to input information including a desired spatial location;
location optimization means representing a data in a smaller size by combining less unit zones when the spatial location is inputted; and
DB registration means enabling the inputted information to be registered in the DB.

2. The information management system of claim 1, further comprising:
DB retrieving means enabling the information to be selected from the DB in response to the inputted request; and
information output means enabling the selected information to be outputted.

3. The information management system of claim 1, wherein at least a part of said terminal comprises:
a space being pre-divided into a plurality of unit zones and re-divided into another plurality of unit zones;
an input unit enabling information or a request to be inputted;
an output unit enabling the information to be verified and outputted, and a database (DB) enabling information including a spatial location to be registered;
information input means enabling the information including a desired spatial location to be inputted;
DB registration means inputted information to be registered in the DB;
request input means enabling a request including a desired spatial condition to be inputted;
DB retrieving means enabling information to be selected from the DB in response to an inputted request;
information output means enabling a selected information to be outputted; and
location optimization means representing a data in a smaller size by combining less unit zones when at least any one of the spatial location and the spatial condition is inputted.

4. The information management system of claim 3, wherein at least a part of said terminal enables at least a part of the information outputted in the DB to be registered, the DB being connected to the host computer.

5. The information management system of claim 4, wherein at least a part of said terminal enables at least a part of the information outputted in the DB to be registered in the DB connected to the host computer.

6. The information management system of claim 4, wherein at least a part of
said terminal enables at least a part of the information registered in the DB to be opened through the communication network; and
at least location information on the communication network of the terminal which opens at least of the part of information to be registered in the host computer and opened.

7. The information management system of claim 1, wherein said host computer
comprises an input unit enabling information or request to be inputted;
an output unit enabling the information or the request to be verified or outputted; and
the host computer is further used as a terminal.

8. The information management system of claim 1, wherein said host computer and the DB are divided a plurality of parts and connected to the communication network, respectively.

9. An information management device enabling information to be registered in a
database (DB) comprising:
a space being pre-divided into a plurality of unit zones and re-divided into another plurality of unit zones;
an input unit enabling information to be inputted;
an output unit enabling information to be verified;
a database (DB) enabling information including a spatial location to be registered;
information input means enabling information including a desired spatial location to be inputted;
DB registration means enabling inputted information in the DB; and
location optimization means representing a data in a smaller size by combining less unit zones when at least a spatial location is inputted.

10. The information management device of claim 9, further comprising:
DB retrieving means enabling information to be selected in the DB in response to an inputted request; and
information output means enabling selected information to be outputted.

11. An information management method of registering information in a database (DB), comprising the steps of:
pre-dividing a space into a plurality of unit zones and re-dividing into at least another plurality of unit zones;
inputting information including a desired spatial location by an information provider;
optimizing location by combining less unit zones and representing a data in a smaller size when a spatial location is inputted; and
registering inputted information in the DB.

12. The information management method of claim 11, further comprising the steps of:
pre-registering information including a spatial location in the DB;
retrieving and selecting information in the DB in response to an inputted request; and
outputting selected information.

13. An information management program enabling information to be registered in a database (DB) in a computer and enabling registered information to be selected, comprising:
a space which is pre-divided into a plurality of unit zones and re-divided into another plurality of unit zones;
information input means in which information including a desired spatial location is inputted by an information provider;
DB registration means in which inputted information is registered in the DB;
request input means in which a request including a spatial condition is inputted by an information recipient;
DB retrieving means in which information is selected in the DB in response to an inputted request;
information output means in which selected information is outputted; and
location optimization means in which less unit zones are combined and a data is represented in a smaller size when at least any one of a spatial location and a spatial condition is inputted.
